SEQUENCE LISTING (12 sequences)

SEQ ID NO: 1 - protein, 32 aa, Bos taurus
RPKHPIKHQGLPQEVLNENLLRFFVAPFPEVC

SEQ ID NO: 2 - protein, 33 aa, Bos taurus
FGKEKVNELSKDIGSESTEDQAMEDIKQMEAES

SEQ ID NO: 3 - protein, 36 aa, Bos taurus
ISSSEEIVPNSVEQKHIQKEDVPSERYLGYEQLLRC

SEQ ID NO: 4 - protein, 34 aa, Bos taurus
CLKKYKVPQLEIVPNSAEERLHSMKEGIHAQQKE

SEQ ID NO: 5 - protein, 35 aa, Bos taurus
CPMIGVNQELAYFYPELFRQFYQLDAYPSGAWYYV

SEQ ID NO: 6 - protein, 33 aa, Bos taurus
PLGTQYTDAPSFSDIPNPIGSENSEKTTMPLWC

SEQ ID NO: 7 - protein, 205 aa, Bos taurus
RPKHPIKHQGLPQEVLNENLLRFFVAPFPEVFGKEKVNELSKDIGSESTEDQAMEDIKQMEAESISSSEEIVPNSVEQKHIQKEDVPSERYLGYLEQLLRLKKYKVPQLEIVPNSAEERLHSMKEGIHAQQKEPMIGVNQELAYFYPELFRQFYQLDAYPSGAWYYVPLGTQYTDAPSFSDIPNPIGSENSEKTTMPLWHHHHHH

SEQ ID NO: 8 - protein, 213 aa, Bos taurus
KNTMEHVSSSEESIISQETYKQEKNMAINPSKENLCSTFCKEVVRNANEEEYSIGSSSEESAEVATEEVKITVDDKHYQKALNEINQFYQKFPQYLQYLYQGPIVLNPWDQVKRNAVPITPTLNREQLSTSEENSKKTVDMESTEVFTKKTKLTEEEKNRLNFLKKISQRYQKFALPQYLKTVYQHQKAMKPWIQPKTKVIPYVRYLHHHHHH

SEQ ID NO: 9 - protein, 159 aa, Betula verrucosa
GVFNYETETTSVIPAARLFKAFILDGDNLFPKVAPQAISSVENIEGNGGPGTIKKISFPEGFPFKYVKDRVDEVDHTNFKYNYSVIEGGPIGDTLEKISNEIKIVATPDGGSILKISNKYHTKGDHEVKAEQVKASKEMGETLLRAVESYLLAHSDAYN

SEQ ID NO: 10 - protein, 32 aa, Phleum pratense
CGAASNKAFAEGLSGEPKGAAESSSKAALTSK

SEQ ID NO: 11 - protein, 199 aa, Bos taurus
RPKHPIKHQGLPQEVLNENLLRFFVAPFPEVFGKEKVNELSKDIGSESTEDQAMEDIKQMEAESISSSEEIVPNSVEQKHIQKEDVPSERYLGYLEQLLRLKKYKVPQLEIVPNSAEERLHSMKEGIHAQQKEPMIGVNQELAYFYPELFRQFYQLDAYPSGAWYYVPLGTQYTDAPSFSDIPNPIGSENSEKTTMPLW

SEQ ID NO: 12 - protein, 207 aa, Bos taurus
KNTMEHVSSSEESIISQETYKQEKNMAINPSKENLCSTFCKEVVRNANEEEYSIGSSSEESAEVATEEVKITVDDKHYQKALNEINQFYQKFPQYLQYLYQGPIVLNPWDQVKRNAVPITPTLNREQLSTSEENSKKTVDMESTEVFTKKTKLTEEEKNRLNFLKKISQRYQKFALPQYLKTVYQHQKAMKPWIQPKTKVIPYVRYL

(19) United States
(12) Patent Application Publication
(10) Pub. No.: US 2011/0195153 A1
(43) Pub. Date: Aug. 11, 2011

(54) Nutritional Formulation Comprising A Cows Milk Peptide Containing Hydrolysate And Or Peptides Derived Thereof For Tolerance Induction

(75) Inventors: RUDOLF VALENTA, VIENNA (AT); ERIC VAN TOL, ARNHEM (NL); UDO HERZ, KIRCHHAIN (DE); HEIDRUN HOCHWALLNER, ST. LEONHARD/FORST (AT); MARGARETE FOCKE-TEJKL, VIENNA (AT); INES SWOBODA, VIENNA (AT); ULRIKE SCHULMEISTER, WALDHAUSEN (AT)

(73) Assignee: MEAD JOHNSON NUTRITION COMPANY, EVANSVILLE, IN (US)

(21) Appl. No.: 12/959,956

(22) Filed: Dec. 3, 2010

(30) Foreign Application Priority Data
Dec. 4, 2009 (EP) 09015087.1

(51) Int. Cl. A23C 9/20; A23C 9/158; A23C 9/152

(52) U.S. Cl. 426/61; 426/580; 426/72; 426/74

(57) ABSTRACT

A nutritional formulation or supplement comprising a cow's milk peptide-containing hydrolysate and/or peptide-containing fraction of the hydrolysate and/or one or more peptides derived from a protein present in cow's milk for use in the induction of tolerance in a human subject, wherein said peptides contained in the hydrolysate or fraction of hydrolysate comprise T cell epitope-containing peptides or wherein said one or more peptides are T cell epitope-containing peptides, and wherein said T cell epitope-containing peptides are capable of driving the immune reaction upon intake of the nutritional formulation towards tolerance.

### TECHNICAL FIELD

The present disclosure relates to a nutritional formulation or supplement comprising a cow's milk peptide-containing hydrolysate and/or peptide-containing fraction of the hydrolysate and/or one or more peptides derived from a protein present in cow's milk for use in the induction of tolerance in a human subject, wherein said peptides contained in the hydrolysate or fraction of hydrolysate comprise T cell epitope-containing peptides or wherein said one or more peptides are T cell epitope-containing peptides, and wherein said T cell epitope-containing peptides are capable of driving the immune reaction upon intake of the nutritional formulation towards tolerance.

### BACKGROUND

Cow's milk allergy is one of the most common food allergies in young children, with approximately 2% to 2.5% of all infants experiencing allergic reactions to milk. The majority of children out-grow their allergy to cow's milk before the age of 3, but 15% of these infants will retain their sensitivity to cow's milk into the second decade of life. Therefore, subjects having a cow's milk allergy are present in all age groups. Allergic diseases like milk allergy are immunological disorders which originate from the activation of a subset of T cells secreting allergic, inflammatory factors including IL-4, IL-5 and/or IL-13 (Schmidt-Weber et al., Allergy 2002, Vol 57, pp 762-768). This subset of T cells controls the isotype switching of antigen-specific B cells to IgE and therefore plays a key role in the initiation of allergic symptoms, as well as in tolerance induction (Kondo et al., Pediatr. Allergy Immunol. 2008, Vol. 19, pp 592-598). Hence, the regulation of allergen-specific T cells is a promising strategy to control allergic diseases.

In order to avoid allergic reactions upon exposure to cow's milk in a cow's milk allergic subject, and in particular in infants having a cow's milk allergy, mostly milk substitute formulas are presently used which replace nutrition with cow's milk. These formulas additionally provide the subject with a complete source of nutrition. Milk substitutes include free amino acids (such as Nutramigen™ AA, Neocate), soy based formulas (such as Pregomin), or hypoallergenic formulas based on partially or extensively hydrolyzed protein (such as Nutramigen™, Alimentum, and Pregestemil). If allergic subjects do not respond to protein hydrolysate formulas, non-milk derived amino acid-based formulas are suitable for the treatment of both mild-moderate and severe milk allergy. Soy based formulas have a risk of allergic sensitivity, as some subjects who are allergic to milk may also be allergic to soy. Partial hydrolysate formulas are characterized by a larger proportion of long amino acid chains (peptides) compared to extensive hydrolysates and are considered more palatable. They are usually intended for prophylactic use and are generally not considered suitable for treatment of milk allergy/intolerance. Extensively hydrolysed proteins, on the other hand, comprise predominantly free amino acids and short peptides. Casein and whey are the most commonly used sources of protein for hydrolysates because of their high nutritional quality and their amino acid composition.

Hence, most of today's cow's milk substitute formulas on the market are based on cow's milk that has been hydrolyzed to various degrees and/or on amino acid formulations. These cow's milk formulas are used to replace cow milk and thereby reduce allergic reactions in cow's milk allergic subjects. Moreover, cow's milk formulas can potentially prevent the development of cow's milk allergy in a subject being at risk of developing a milk allergy. However, even extensively hydrolyzed products have occasionally been observed to elicit allergic reactions in sensitized infants (Rosendal et al. Journal of Dairy Science 2000, Vol. 83, No. 10, pp 2200-2210).

The current treatment for milk allergies is therefore the total avoidance of cow's milk and food. Consequently, a substance which could drive the immune reaction upon intake of the substance towards tolerance to cow's milk or food comprising cow's milk would drastically increase the quality of life of a subject having cow's milk allergy or having the risk of developing a cow's milk allergy. This need is addressed by the present disclosure.

### SUMMARY OF THE DISCLOSURE

Accordingly, the present disclosure relates in one embodiment to a nutritional formulation or supplement comprising a cow's milk peptide-containing hydrolysate and/or peptide-containing fraction of the hydrolysate and/or one or more peptides derived from a protein present in cow's milk for use in the induction of tolerance in a human subject, wherein said peptides contained in the hydrolysate or fraction of hydrolysate comprise T cell epitope-containing peptides or wherein said one or more peptides are T cell epitope-containing peptides, and wherein said T cell epitope-containing peptides are capable of driving the immune reaction upon intake of the nutritional formulation towards tolerance.

### BRIEF DESCRIPTION OF THE DRAWINGS

The Figures show:

FIGS. 1-13 illustrate the luminex-analyses that were performed in the supernatants of PBMCs in order to analyze which cytokines are induced in PBMCs by the different milk samples (VTP1-VTP16). Analysis of cytokine levels (y-axis: pg/ml) in supernatants of PBMC cultures from 6 non-allergic individuals (NA) and 5 cow's milk allergic patients (CMA) which had been stimulated with milk samples VTP1-VTP16 (1-16) or medium (17) are displayed. Fluorescent signals were read on a Luminex 100 system.

More specifically, FIG. 1A illustrates levels of interleukin 2 (IL-2) measured in supernatant collected from PBMC cultures from six non-allergic individuals at day six of culture using xMAP Luminex fluorescent bead-based technology. The range of detection was 3.2-2350 pg/ml.

FIG. 1B illustrates levels of IL-2 measured in supernatant collected from peripheral blood mononuclear cell (PBMC) cultures from five cow's milk allergic patients at day six of culture using xMAP Luminex fluorescent bead-based technology. The range of detection was 3.2-2350 pg/ml.

FIG. 2A illustrates levels of interleukin 4 (IL-4) measured in supernatant collected from PBMC cultures from six non-allergic individuals at day six of culture using xMAP Luminex fluorescent bead-based technology. The range of detection was 3.5-2575 pg/ml.

FIG. 2B illustrates levels of IL-4 measured in supernatant collected from PBMC cultures from five cow's milk allergic patients at day six of culture using xMAP Luminex fluorescent bead-based technology. The range of detection was 3.5-2575 pg/ml.

FIG. 3A illustrates levels of interleukin 5 (IL-5) measured in supernatant collected from PBMC cultures from six non-allergic individuals at day six of culture using xMAP Luminex fluorescent bead-based technology. The range of detection was 1.9-1400 pg/ml.

FIG. 3B illustrates levels of IL-5 measured in supernatant collected from PBMC cultures from five cow's milk allergic patients at day six of culture using xMAP Luminex fluorescent bead-based technology. The range of detection was 1.9-1400 pg/ml.

FIG. 4A illustrates levels of interleukin 6 (IL-6) measured in supernatant collected from PBMC cultures from six non-allergic individuals at day six of culture using xMAP Luminex fluorescent bead-based technology. The range of detection was 5.5-4000 pg/ml.

FIG. 4B illustrates levels of IL-6 measured in supernatant collected from PBMC cultures from five cow's milk allergic patients at day six of culture using xMAP Luminex fluorescent bead-based technology. The range of detection was 5.5-4000 pg/ml.

FIG. 5A illustrates levels of interleukin 10 (IL-10) measured in supernatant collected from PBMC cultures from six non-allergic individuals at day six of culture using xMAP Luminex fluorescent bead-based technology. The range of detection was 3.1-2250 pg/ml.

FIG. 5B illustrates levels of IL-10 measured in supernatant collected from PBMC cultures from five cow's milk allergic patients at day six of culture using xMAP Luminex fluorescent bead-based technology. The range of detection was 3.1-2250 pg/ml.

FIG. 6A illustrates levels of interferon-gamma (IFN-gamma) measured in supernatant collected from PBMC cultures from six non-allergic individuals at day six of culture using xMAP Luminex fluorescent bead-based technology. The range of detection was 2.9-2100 pg/ml.

FIG. 6B illustrates levels of IFN-gamma measured in supernatant collected from PBMC cultures from five cow's milk allergic patients at day six of culture using xMAP Luminex fluorescent bead-based technology. The range of detection was 2.9-2100 pg/ml.

FIG. 7A illustrates levels of tumor necrosis factor-alpha (TNF-alpha) measured in supernatant collected from PBMC cultures from six non-allergic individuals at day six of culture using xMAP Luminex fluorescent bead-based technology. The range of detection was 5.3-3900 pg/ml.

FIG. 7B illustrates levels of TNF-alpha measured in supernatant collected from PBMC cultures from five cow's milk allergic patients at day six of culture using xMAP Luminex fluorescent bead-based technology. The range of detection was 5.3-3900 pg/ml.

FIG. 8A illustrates levels of granulocyte macrophage colony stimulating factor (GM-CSF) measured in supernatant collected from PBMC cultures from six non-allergic individuals at day six of culture using xMAP Luminex fluorescent bead-based technology. The range of detection was 3.3-2400 pg/ml.

FIG. 8B illustrates levels of GM-CSF measured in supernatant collected from PBMC cultures from five cow's milk allergic patients at day six of culture using xMAP Luminex fluorescent bead-based technology. The range of detection was 3.3-2400 pg/ml.

FIG. 9A illustrates levels of interleukin 12 (IL-12) measured in supernatant collected from PBMC cultures from six non-allergic individuals at day six of culture using xMAP Luminex fluorescent bead-based technology. The range of detection was 57-41500 pg/ml.

FIG. 9B illustrates levels of IL-12 measured in supernatant collected from PBMC cultures from five cow's milk allergic patients at day six of culture using xMAP Luminex fluorescent bead-based technology. The range of detection was 57-41500 pg/ml.

FIG. 10A illustrates levels of interleukin 13 (IL-13) measured in supernatant collected from PBMC cultures from six non-allergic individuals at day six of culture using xMAP Luminex fluorescent bead-based technology. The range of detection was 47-34500 pg/ml.

FIG. 10B illustrates levels of IL-13 measured in supernatant collected from PBMC cultures from five cow's milk allergic patients at day six of culture using xMAP Luminex fluorescent bead-based technology. The range of detection was 47-34500 pg/ml.

FIG. 11A illustrates levels of transforming growth factor beta 1 (TGF-β1) measured in supernatant collected from PBMC cultures from six non-allergic individuals at day six of culture using xMAP Luminex fluorescent bead-based technology. The range of detection was 33.3-24300 pg/ml.

FIG. 11B illustrates levels of TGF-β1 measured in supernatant collected from PBMC cultures from five cow's milk allergic patients at day six of culture using xMAP Luminex fluorescent bead-based technology. The range of detection was 33.3-24300 pg/ml.

FIG. 12A illustrates levels of transforming growth factor beta 2 (TGF-β2) measured in supernatant collected from PBMC cultures from six non-allergic individuals at day six of culture using xMAP Luminex fluorescent bead-based technology. The range of detection was 17.1-12500 pg/ml.

FIG. 12B illustrates levels of TGF-β2 measured in supernatant collected from PBMC cultures from five cow's milk allergic patients at day six of culture using xMAP Luminex fluorescent bead-based technology. The range of detection was 17.1-12500 pg/ml.

FIG. 13A illustrates levels of transforming growth factor beta 3 (TGF-β3) measured in supernatant collected from PBMC cultures from six non-allergic individuals at day six of culture using xMAP Luminex fluorescent bead-based technology. The range of detection was 68.3-49850 pg/ml.

FIG. 13B illustrates levels of TGF-β3 measured in supernatant collected from PBMC cultures from five cow's milk allergic patients at day six of culture using xMAP Luminex fluorescent bead-based technology. The range of detection was 68.3-49850 pg/ml.

FIG. 14 illustrates that tolerance experiments with a non-allergic individual (AB) were performed to show that peptides can tolerize T-cells in allergen-specific manner. Experiments in non-allergic persons can also show tolerance because tolerance is measured as reduction of T cell reactivity (Ebner et al., J. Immunol. 1995, Vol 154, pp 1932-1940). As long as a non-allergic person contains allergen-reactive T cells, tolerance to the allergen at the T cell level can be measured.

PBMCs were isolated and T-cell- and antigen-presenting cell (APC)-enriched fractions were obtained by MACS-separation technology. T-cell fractions were preincubated over night with high amounts of peptides (αS1-casein peptide 1, αS1-casein peptide 2, αS1-casein peptide 3 and a control peptide, Phl p 5-peptide 1) or with an extensive whey hydrolysate (VTP8) or partial whey/casein hydrolysate (VTP16). On the next day the T-cells and the APCs were combined and stimulated with whole cow's milk protein samples (VTP13, VTP14) or with intact rαS1-casein.

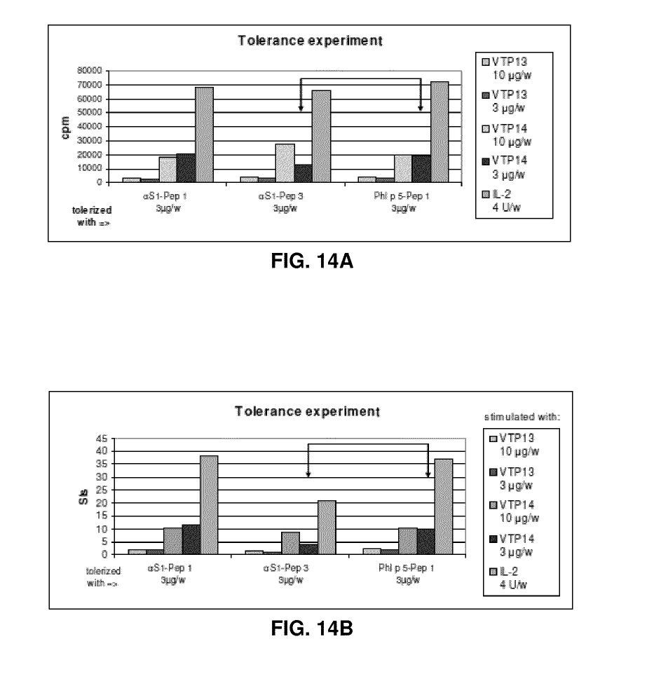

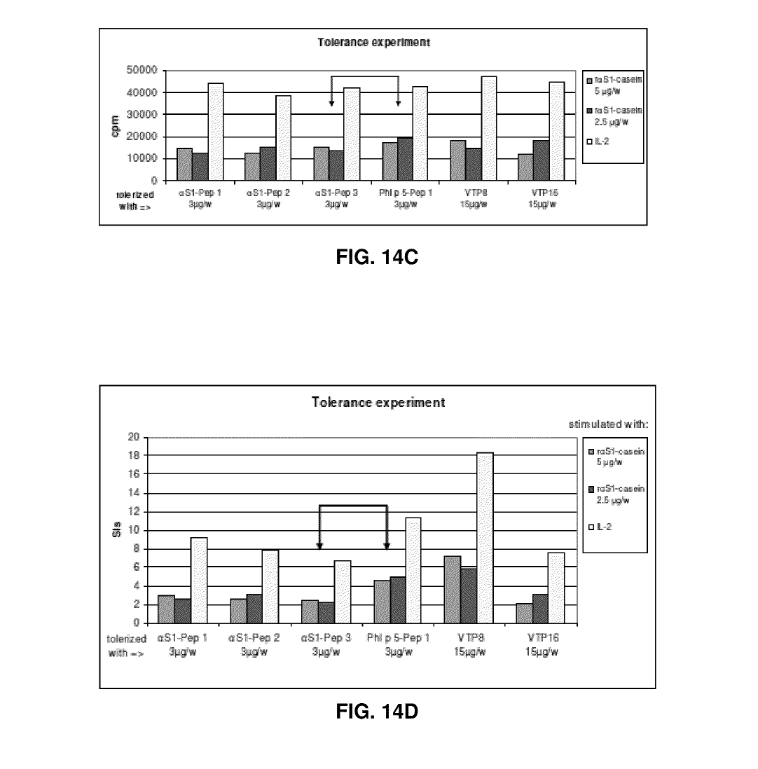

Two experiments were performed with the same individual. In FIGS. 14A and 14C, counts per minute (cpm; reflecting the proliferation of T cells) and in FIGS. 14B and 14D, stimulation indices (SIs) are displayed.

More specifically, FIG. 14A illustrates the counts per minute (cpm; reflecting the proliferation of T cells) in T-cell fractions preincubated overnight with high amounts of peptides (αS1-casein peptide 1, αS1-casein peptide 3 and a control peptide, Phl p 5-peptide 1) that were combined and stimulated the next day with whole cow's milk protein samples (VTP13, VTP14) or with IL-2.

FIG. 14B illustrates the stimulation indices for T-cell fractions preincubated overnight with high amounts of peptides (αS1-casein peptide 1, αS1-casein peptide 3 and a control peptide, Phl p 5-peptide 1) that were combined and stimulated the next day with whole cow's milk protein samples (VTP13, VTP14) or with IL-2.

FIG. 14C illustrates the counts per minute (cpm; reflecting the proliferation of T cells) in T-cell fractions preincubated overnight with high amounts of peptides (αS1-casein peptide 1, αS1-casein peptide 2, αS1-casein peptide 3 and a control peptide, Phl p 5-peptide 1) or with an extensive whey hydrolysate (VTP8) or partial whey/casein hydrolysate (VTP16) that were combined and stimulated the next day with intact rαS1-casein or with IL-2.

FIG. 14D illustrates the stimulation indices for T-cell fractions preincubated overnight with high amounts of peptides (αS1-casein peptide 1, αS1-casein peptide 2, αS1-casein peptide 3 and a control peptide, Phl p 5-peptide 1) or with an extensive whey hydrolysate (VTP8) or partial whey/casein hydrolysate (VTP16) that were combined and stimulated the next day with intact rαS1-casein or with IL-2.

### DETAILED DESCRIPTION

The term “nutritional formulation” as used herein describes a solid or liquid formulation which can be eaten or drunk by a human subject for nutrition. The nutritional formulation of the disclosure preferably has a nutritional value of at least 1, more preferred at least 10 and even more preferred 50 kcal (kilo calorie)/100 ml for liquid formulations and preferably at least 1, more preferred at least 10, even more preferred at least 50, such as at least 100, and most preferred at least 300 kcal/100 g for dry food formulations. In a preferred embodiment of the disclosure the nutritional formulation of the disclosure has a nutritional value of at least 50-200 kcal/100 ml for liquid formulations and at least 300-600 kcal/100 g for dry food formulations. A nutritional formulation is distinguished from a vaccine. In contrast to a vaccine, a nutritional formulation does not comprise any of adjuvants (unless as contaminations), activated or inactivated viral compounds (unless as contaminations), and/or pathogenic compounds (unless as contaminations).

The term “supplement” as used herein relates to a nutritional supplement, which is a concentrated source of nutrient or alternatively other substances with a nutritional or physiological effect whose purpose is to supplement the normal diet.

In addition to the above recited ingredients, further ingredients may be selected from lipids, minerals, carbohydrates, amino acids, amino acid chelates, anabolic nutrients, vitamins, antioxidants, probiotics and lipotropic agents in order to provide an optimal sustained energy and anabolic nutritional formulation.

The nutritional formulation may be a nutritional supplement or may provide complete nutrition. Preferably the nutritional formulation is in the form of a dry food concentrate. The nutritional formulation of the disclosure provides a human subject with increasing preference with at least 5%, at least 10%, at least 25%, at least 50%, at least 75% or at least 90% of the daily calorie requirement of a human subject. The person skilled in the art is well aware that the daily calorie requirement is dependent on the gender, height and age of a human subject. For example, a 30 year old male of 80 kg body weight and 180 cm height has a daily calorie requirement of around 2900 cal (calories) to maintain his body weight whereas a 30 year old female of 55 kg body weight and 165 cm height has a daily calorie requirement of around 2100 cal to maintain her body weight. In a preferred embodiment, the nutritional formulation of the present disclosure is an infant or a nutritional product for infants or juveniles.

The term “peptide” as used herein describes linear molecular chains of amino acids, including single chain molecules or their fragments. A peptide in accordance with the disclosure contains with increasing preference about 2 to 100 amino acids, about 5 to 50 amino acids, or about 5 to 40 amino acids. Peptides may further form oligomers or multimers consisting of at least two identical or different molecules. The corresponding higher order structures of such multimers are, correspondingly, termed homo- or heterodimers, homo- or heterotrimers etc. Furthermore, peptidomimetics of such peptides where amino acid(s) and/or peptide bond(s) have been replaced by functional analogs are also encompassed by the term “peptide”. Such functional analogues include all known amino acids other than the 20 gene-encoded amino acids, such as selenocysteine.

The term “peptide” also refers to naturally modified peptides where the modification is effected e.g. by glycosylation, acetylation, phosphorylation and similar modifications which are well known in the art. A peptide has to be distinguished from a protein in the present disclosure. A protein in accordance with the present disclosure describes an organic compound made of amino acids arranged in a linear chain and folded into a globular form. Furthermore, a protein in accordance with the present disclosure describes an amino acids of more than 100 amino acids. Peptides may, e.g., be produced recombinantly, (semi-) synthetically, or obtained from natural sources such as after hydrolysation of proteins, all according to methods known in the art.

The term “cow's milk peptide-containing hydrolysate” as used herein defines a formula which comprises peptides derived from hydrolyzed cow's milk proteins (e.g. bovine casein or bovine whey). In this regard, a hydrolyzed protein is a protein that has been broken down into peptides and/or component amino acids. While there are many means of achieving protein hydrolysis, two of the most common means are prolonged boiling in a strong acid or strong base or using an enzyme such as the pancreatic protease enzyme to stimulate the naturally-occurring hydrolytic process. Hydrolysis of proteins derived from milk is preferably achieved using an enzyme or a mixture of enzymes. A cow milk hydrolysate can comprise peptides derived from milk, wherein the proteins of said milk have been hydrolyzed to various degrees. Accordingly, one can distinguish between a partially hydrolyzed cow's milk peptide-containing hydrolysate and an extensively hydrolyzed cow's milk peptide-containing hydrolysate. In this regard, a partially hydrolyzed cow's milk peptide-containing hydrolysate comprises more than 20% of intact cow's milk protein whereas an extensively hydrolyzed cow's milk peptide-containing hydrolysate comprises less than 1% of peptides having a size of greater than 1.5 kD. Furthermore, an extensively hydrolyzed cow's milk peptide-containing hydrolysate is preferably hypoallergenic.

The term “peptide derived from cow's milk” as used herein defines a peptide which has an amino acid sequence which is a partial amino acid sequence of a cow's milk protein. Such peptides may be obtained as outlined above by hydrolysis or may be synthesized in vitro by methods known to the skilled person and described in the examples of the disclosure.

The term “T cell epitope-containing peptide” in accordance with the disclosure describes a peptide which comprises an epitope that is capable of binding to a surface receptor present on a T-cell. It is preferred that the epitope is capable of binding to a T cell receptor (TCR).

The term “peptide-containing fraction of the hydrolysate” refers to a mixture of peptides comprising at least 2, preferably at least 5, more preferably at least 10 and most preferably at least 20 which have been isolated from the hydrolysate of the disclosure by filtration techniques that are known to the skilled person. Furthermore, techniques for the isolation of peptides from the hydrolysate of the disclosure are described herein below.

The term “tolerance” according to the disclosure refers to an immunological tolerance. Immunological tolerance is defined herein as the development of specific non-reactivity or partial non-reactivity of lymphoid tissues to a particular antigen or group of antigens. This particular antigen or group of antigens is capable of inducing an immune reaction in an atopic human subject upon intake of the particular antigen or group of antigens. Accordingly, tolerance to the particular antigen or group of antigens in accordance with the present disclosure is induced upon intake of one or more T cell epitope-containing peptides of the disclosure. Without wishing to be bound by theory, tolerance may be induced, for example, by mechanism of anergy and deletion of specific allergen-reactive T cells. Alternatively, tolerance may, for example, be induced by cellular factor (i.e. cytokines) which could drive the T cell development in the direction of the development of a tolerogenic or suppressive T cell phenotype (regulatory T cells).

In this regard, the term “T cell epitope-containing peptides capable to drive the immune reaction upon intake of the nutritional formulation towards tolerance” specifies peptides which contribute to the development of specific non-reactivity of lymphoid tissues to a particular antigen or group of antigens, wherein this activity of the peptide is achieved by binding to a T cell surface receptor. Accordingly, the T cell epitope-containing peptides are present in an amount in the nutritional formation which allows for driving the immune reactions towards tolerance. It is preferred that the immune reaction is reduced by the induction of tolerance by at least 20%, such as at least 50%, such as by at least 75%, preferably by at least 90%, more preferably by at least 95%, and most preferably by 100% as compared to the immune reaction upon contact with the antigen without prior tolerance induction. Methods for measuring tolerance are known in the art and include for example the methods described in the examples of the disclosure.

Accordingly, tolerance may be determined for example by measuring the amount of proinflammatory factors released from T cells (e.g. interleukins or interferones) or the proliferation of T cells. A peptide that is a T cell epitope-containing peptide capable of driving the immune reaction upon intake of the nutritional formulation towards tolerance can be identified by methods known to the skilled person in the art which are, for example, described in the examples of the disclosure herein below. Accordingly, a peptide that can inhibit the proliferation of T cells, and/or downregulate the release of pro-inflammatory cytokines and/or cytokines driving T helper cell 2 (TH2) differentiation released in the supernatant of peripheral blood mononuclear cells (PBMCs) is a T cell epitope-containing peptide capable of driving the immune reaction upon intake of the nutritional formulation towards tolerance.

In accordance with the present disclosure, it has surprisingly been found that T cell epitope-containing peptides contained in cow's milk hydrolysate and T cell epitope-containing peptides that are derived from a protein present in cow's milk can be used in the induction of tolerance. As is evident from the examples below, the inventors have found that peptides contained in milk hydrolysates and peptides derived from a protein present in cow's milk can drastically decrease proliferation of T cells when there is a subsequent exposure to milk allergens, presumably via blocking T cell receptors and major histocompatibility complex class II (MHCII) binding. Specific peptides contained in milk hydrolysates or synthetic peptides corresponding to a partial sequence of a cow's milk peptide can even block proliferation of T cells when there is a subsequent exposure to milk allergens.

While T-cell epitopes in cow's milk proteins have been described in the art (e.g. Kondo et al., Pediatr. Allergy Immunol. 2008, Vol. 19, pp 592-598; Elsayed et al., Mol. Immunol. 2004, Vol 41(12), pp 1225-34; Ruiter et al., Clin. Exp. Allergy 2006, Vol 36(3), pp 303-10; Ruiter et al., Int. Arch. Allergy Immunol. 2007; Vol 143(2), pp 119-26; or Nakajima-Adachi et al., J. Allergy Clin. Immunol. 1998; Vol 101(5), pp 660-71), it has not been described previously that cow's milk derived peptides can induce tolerance. Further, in accordance with the present disclosure it has also been found that T cell epitope-containing peptides contained in cow's milk hydrolysate and T cell epitope-containing peptides that are derived from a protein present in cow's milk reduce levels of cytokines driving a T-helper cell 2 (TH2) differentiation and levels of pro-inflammatory cytokines as compared to levels of said cytokines induced by milk proteins.

As known in the field on immunology, pro-inflammatory cytokines have detrimental effects on the intestinal barrier integrity and therefore are involved in the development of allergic and/or inflammatory disease. Amongst pro-inflammatory cytokines, in particular, IL-4 and IFN-gamma are known to destruct the coherence between the epithelial cells lining the gut surface, thus compromising the intestinal barrier integrity. As a result of this, the intestine becomes more permeable with increased exposure of allergens and dietary/microbial antigens to the immune cells in the gut wall.

Thus, without wishing to be bound by theory, tolerance is believed to be induced directly by cow's milk derived peptides. Previously cow's milk hydrolysates and peptides have only been used in order to replace cow's milk. By the replacement of cow's milk an allergic reaction or the development of an allergic reaction has been avoided. The findings provided herein show that peptides that are T cell epitope-containing peptides contained in cow's milk hydrolysate and T cell epitope-containing peptides that are derived from a protein present in cow's milk can moreover and unexpectedly be used to induce tolerance in a human subject.

In a preferred embodiment, the disclosure relates to the nutritional formulation described above, wherein the tolerance is induced to cow's milk, a protein contained in cow's milk or an allergen contained in cow's milk.

Cow's milk, a protein contained in cow's milk or an allergen contained in cow's milk are, for example, comprised in any food comprising cow's milk ingredients. Non-limiting examples are milk, curd, cream, butter, yogurt and food containing any of these.

Then term “allergen” as used herein describes an antigen capable of stimulating a hypersensitivity reaction in an atopic (allergic) human subject. Furthermore, an allergen is in general a substance that is foreign to the body and can cause an allergic reaction only in atopic human subjects.

The present disclosure further relates to a nutritional formulation or supplement comprising a cow's milk peptide-containing hydrolysate and/or peptide-containing fraction of the hydrolysate and/or one or more peptides derived from a protein present in cow's milk for use in treating or preventing inflammatory bowel disease, wherein said peptides contained in the hydrolysate or fraction of hydrolysate comprise T cell epitope-containing peptides or wherein said one or more peptides are T cell epitope-containing peptides, and wherein said T cell epitope-containing peptides are capable of downregulating pro-inflammatory cytokines upon intake of the nutritional formulation.

The term “inflammatory bowel disease” as used herein defines a group of inflammatory conditions of the gastrointestinal tract. The major types of inflammatory bowel disease are Crohn's disease and ulcerative colitis. The main difference between Crohn's disease and ulcerative colitis is the location and nature of the inflammatory changes. Crohn's disease can affect any part of the gastrointestinal tract, from mouth to anus (skip lesions), although a majority of the cases start in the terminal ileum. Ulcerative colitis, in contrast, is restricted to the colon and the rectum. In a preferred embodiment the inflammatory bowel disease is present in a human subject having a milk allergy or having the risk of developing a milk allergy. In a further preferred embodiment the inflammatory bowel disease is selected from one or more of Crohn's disease, ulcerative colitis, gastro esophageal reflux disease (GERD), gastroenteritis, colitis and/or esophagitis. GERD is a disease produced by the abnormal reflux in the esophagus. In particular, gastro esophageal reflux disease (GERD), gastroenteritis, colitis and/or esophagitis are common in human subjects having a cow's milk allergy.

In connection with the present disclosure, the term “pro-inflammatory cytokines” are cytokines that are released in a human subject by cells of the immune system, preferably by antigen-presenting cells or T cells and most preferably by T cells that mediate and/or enhance an inflammatory disease. Non-limiting examples of inflammatory cytokines are IL-12, IL-17, IL-5, IL-4, IFN-γ, IL-8, TNF-α, IL-6 or IL-1. Methods for measuring the level of cytokine released by cells of the immune system are well know to the skilled person and include the methods described in the examples. Accordingly, the methods include, for example, measuring cytokine levels in culture supernatants.

The term “T cell epitope-containing peptides capable of downregulating pro-inflammatory cytokines upon intake of the nutritional formulation” refers to T cell epitope-containing peptides in the nutritional formulation which can downregulate the levels of pro-inflammatory cytokines that are released form immune cells, preferably T cells or APCs, and more preferably T cells. Furthermore, theses T cell epitope-containing peptides capable are administered to a human subject in an amount that is sufficient to downregulate pro-inflammatory cytokines upon intake of the nutritional formulation.

It is preferred that the level of pro-inflammatory cytokines is downregulated by at least 20%, at least 50%, at least 75%, preferably by at least 90%, more preferably by at least 95%, and most preferably by 100% as compared to the level of pro-inflammatory cytokines in an atopic immune reaction upon contact with the antigen. A peptide that is a T cell epitope-containing peptide capable of downregulating pro-inflammatory cytokines upon intake of the nutritional formulation by a subject can be identified by methods known to the skilled person in the art which are, for example, described in the examples of the disclosure herein below. Accordingly, measuring the level of pro-inflammatory cytokines released in the culture supernatant of PBMCs upon exposure to a peptide identifies a T cell epitope-containing peptide capable of down-regulating pro-inflammatory cytokines upon intake of the nutritional formulation.

As described herein it has been surprisingly found in accordance with the present disclosure that T cell epitope-containing peptides of the disclosure derived from cow's milk are capable of downregulating inflammatory cytokines that are released upon exposure to or stimulation by allergens or dietary/microbial antigens. Therefore, the nutritional formulation of the disclosure is suitable to treat, for example, inflammatory bowel disease.

A preferred embodiment of the disclosure relates to the nutritional formulation of the disclosure, wherein the one or more peptides are T cell epitope-containing peptides isolated from the cow's milk peptide-containing hydrolysate.

As detailed above, the cow's milk peptide-containing hydrolysate comprises peptides derived from hydrolyzed cow's milk proteins. These peptides may be isolated from the milk peptide-containing hydrolysate by standard techniques well known to the person skilled in the art.

Accordingly, an analytical purification generally utilizes at least one of three properties to separate peptides. First, peptides may be purified according to their isoelectric points by running them through a pH graded gel or an ion exchange column. Second, peptides can be separated according to their size or molecular weight via size exclusion chromatography or by SDS-PAGE (sodium dodecyl sulfate-polyacrylamide gel electrophoresis) analysis. Third, another peptide purification methodology could involve membrane filtration (e.g. ultra filtration), which would generate a mixture of peptides suitable for the proposed application. Peptides are often purified by using 2D-PAGE and are then analyzed by peptide mass fingerprinting to establish the peptide identity. The isolated and identified peptide obtained from the hydrolysate may then be recombinantly produced by applying standard methods known to the skilled person and may either be used alone or in combination with a cow's milk peptide-containing hydrolysate in accordance with the disclosure.

Another preferred embodiment of the disclosure relates to the nutritional formulation of the disclosure, wherein the one or more peptides has the amino acid sequence of SEQ ID NO: 3 and/or 4, as shown in Table 1.

Table 1 identifies synthetic peptides and proteins. The name of the peptides or protein, their amino acid sequence, length, pI and molecular weight in kDa are listed.

TABLE 1

| Peptide/ | | Length | | MW | |
|---|---|---|---|---|---|
| Protein | Sequence | (aa) | pl | (kDa) | SEQ ID |
| Cas1 | RPKHPIKHQGLPQEVLNENLLRFFVAPFPEVC | 32 | 8.22 | 3.75 | NO: 1 |
| Cas2 | FGKEKVNELSKDIGSESTEDQAMEDIKQMEA | 33 | 4.18 | 3.70 | NO: 2 |
| | ES | | | | |
| Cas3 | ISSSEEIVPNSVEQKHIQKEDVPSERYLGYEQ | 36 | 4.80 | 4.21 | NO: 3 |
| | LLRC | | | | |
| Cas4 | CLKKYKVPQLEIVPNSAEERLHSMKEGIHAQQ | 34 | 8.14 | 3.96 | NO: 4 |
| | KE | | | | |
| Cas5 | CPMIGVNQELAYFYPELFRQFYQLDAYPSGA | 35 | 4.14 | 4.24 | NO: 5 |
| | WYYV | | | | |
| Cas6 | PLGTQYTDAPSFSDIPNPIGSENSEKTTMPLW | 33 | 3.92 | 3.60 | NO: 6 |
| | C | | | | |
| raS1 | RPKHPIKHQGLPQEVLNENLLRFFVAPFP | 205 | 5.35 | 23.80 | NO: 7 |
| casein | EVFGKEKVNELSKDIGSESTEDQAMEDIK | | | | |
| | QMEAESISSSEEIVPNSVEQKHIQKEDVP | | | | |
| | SERYLGYLEQLLRLKKYKVPQLEIVPNSA | | | | |
| | EERLHSMKEGIHAQQKEPMIGVNQELAY | | | | |
| | FYPELFRQFYQLDAYPSGAWYYVPLGTQ | | | | |
| | YTDAPSFSDIPNPIGSENSEKTTMPLWHH | | | | |
| | HHHH | | | | |
| raS1 | KNTMEHVSSSEESIISQETYKQEKNMAIN | 213 | 8.35 | 25.17 | NO: 8 |
| casein | PSKENLCSTFCKEVVRNANEEEYSIGSSS | | | | |
| | EESAEVATEEVKITVDDKHYQKALNEINQ | | | | |
| | FYQKFPQYLQYLYQGPIVLNPWDQVKRN | | | | |
| | AVPITPTLNREQLSTSEENSKKTVDMEST | | | | |
| | EVFTKKTKLTEEEKNRLNFLKKISQRYQK | | | | |
| | FALPQYLKTVYQHQKAMKPWIQPKTKVIP | | | | |
| | YVRYLHHHHHH | | | | |
| rBetv | GVFNYETETTSVIPAARLFKAFILDGDNLF | 159 | 5.4 | 17.4 | NO: 9 |
| 1a | PKVAPQAISSVENIEGNGGPGTIKKISFPE | | | | |
| | GFPFKYVKDRVDEVDHTNFKYNYSVIEG | | | | |
| | GPIGDTLEKISNEIKIVATPDGGSILKISNK | | | | |
| | YHTKGDHEVKAEQVKASKEMGETLLRAV | | | | |
| | ESYLLAHSDAYN | | | | |
| Phl P5- | CGAASNKAFAEGLSGEPKGAAESSSKAA | 32 | 8.16 | 3.03 | NO: 10 |
| peptide 1 | LTSK | | | | |
| na | RPKHPIKHQGLPQEVLNENLLRFFVAPFP | 199 | 7-91 | 22.97 | NOs: 11 |
| casein | EVFGKEKVNELSKDIGSESTEDQAMEDIK | and | and | and | and 12 |
| | QMEAESISSSEEIVPNSVEQKHIQKEDVP | 207 | 8.34 | 24.35 | |
| | SERYLGYLEQLLRLKKYKVPQLEIVPNSA | | | | |
| | EERLHSMKEGIHAQQKEPMIGVNQELAY | | | | |
| | FYPELFRQFYQLDAYPSGAWYYVPLGTQ | | | | |
| | YTDAPSFSDIPNPIGSENSEKTTMPLW | | | | |
| | and | | | | |
| | KNTMEHVSSSEESIISQETYKQEKNMAIN | | | | |
| | PSKENLCSTFCKEVVRNANEEEYSIGSSS | | | | |
| | EESAEVATEEVKITVDDKHYQKALNEINQ | | | | |
| | FYQKFPQYLQYLYQGPIVLNPWDQVKRN | | | | |
| | AVPITPTLNREQLSTSEENSKKTVDMEST | | | | |
| | EVFTKKTKLTEEEKNRLNFLKKISQRYQK | | | | |
| | FALPQYLKTVYQHQKAMKPWIQPKTKVIP | | | | |
| | YVRYL | | | | |

As shown in the examples below, the amino acid sequence of SEQ ID NO: 3 (Table 1, Cas3, alphaS1-peptide 3) and SEQ ID NO: 4 (Table 1, Cas4, alphaS1-peptide 4) suppress the proliferation of T-cells when re-stimulated with cow's milk protein and thereby induced tolerance to the cow's milk protein (Table 1).

A further preferred embodiment of the disclosure relates to the nutritional formulation of the disclosure, wherein the cow's milk peptide containing hydrolysate is an extensively hydrolyzed cow's milk peptide-containing hydrolysate.

A more preferred embodiment of the disclosure relates to the nutritional formulation of the disclosure, wherein the extensively hydrolyzed cow's milk peptide-containing hydrolysate is Nutramigen™, Nutramigen™ base or an extensively hydrolyzed bovine casein hydrolysate.

As is shown in the Examples of the disclosure below, an extensively hydrolyzed cow's milk peptide-containing hydrolysate is able to suppress the proliferation of T-cells when these are re-stimulated with cow's milk protein. Tolerance to the cow's milk protein is thereby induced.

Table 2 provides an overview of the milk test samples named VTP1-VTP16, which were obtained from different suppliers and contained whole cow's milk protein formulas, partially hydrolyzed, and extensively hydrolyzed casein and whey proteins as well as amino acids cow's milk formulas and amino acid formulas.

TABLE 2

| Sample ID | Sample |
|---|---|
| VTP1 | Routine whole milk formula |
| VTP2 | Partial casein/whey hydrolysate product |
| VTP3 | Extensive caseine hydrolysate product (Nutramigen ™) |
| VTP4 | Amino acid formula |
| VTP5 | partial whey hydrolysate product |
| VTP6 | extensive casein hydrolysate product |
| VTP7 | extensive casein hydrolysate product |
| VTP8 | extensive whey hydrolysate product |
| VTP9 | whole milk base |
| VTP10 | partial casein/whey hydrolysate base |
| VTP11 | extensive casein hydrolysate base |
| VTP12 | amino acid base |
| VTP13 | whole milk protein control |
| VTP14 | whey protein concentrate 35% |
| VTP15 | extensive casein hydrolysate only |
| VTP16 | partial casein/whey hydrolysate only |

VTP 3, VTP11 and VTP15 (Table 2) were most potent to induce tolerance and are, therefore, preferred examples of a nutritional formulation comprising an extensively hydrolyzed cow's milk peptide-containing hydrolysate in accordance with the disclosure, VTP3 is Nutramigen™, VTP11 is Nutramigen™ base and VTP15 is the extensively hydrolyzed bovine casein that is used in Nutramigen™. VTP3, VTP 11 and VTP 15 can be purchased via Mead Johnson Nutrition Co., 2400 West Lloyd Expressway Evansville, Ind. 47721-0001, USA. VTP3, VTP 11 and VTP 15 comprise extensively hydrolyzed bovine casein.

A profile of the casein derived peptides comprised in VTP3, VTP 11 and VTP 15 is provided in Table 3. Indeed, Table 3 provides a profile of the casein derived peptides of VTP3, VTP 11 and VTP 15. The Ionscore, the amino acid sequences of the peptides, the hydrophobicity score and the bitterness score are listed.

TABLE 3

| | | hydrophobicity | bitterness |
|---|---|---|---|
| Ionscore | Peptides identified with in Hydrolysate Z0002 | score | score |
| 65 | HQPHQPLPPT | −1.67 | 1414 |
| 63 | HQPHQPLPP | −1.78 | 1522 |
| 61 | YPFPGPIPN | −0.48 | 2107 |
| 56 | PFPGPIP | 0.07 | 2800 |
| 53 | YPFPGPIP | −0.10 | 2371 |
| 50 | PFPGPIPN | −0.38 | 2011 |
| 46 | PFPGPIH | −0.16 | 1997 |
| 46 | PFPGPIPNSLPQ + Deamidation(NQ) | −0.43 | 1756 |
| 45 | YPFPGPI | 0.11 | 2336 |
| 43 | FPGPIPN | −0.20 | 1924 |
| 40 | MHQFHQPLPPT + Oxidation(M) | −1.35 | 1404 |
| 39 | PFPGPIPNSLP + Deamidation(NQ) | −0.15 | 1925 |
| 39 | SWMHQPHQPLPPT + Oxidation(M); Oxidation(HW) | −1.27 | 1422 |
| 35 | HRGHPIG + Oxidation(HW) | −1.26 | 1046 |
| 32 | NILNSE + Deamidation(NQ) | −0.50 | 993 |
| 31 | HKPHFCQPL + Carbamidomethyl(C) | −0.88 | 1412 |
| 30 | CKQGHPGIPGNPGHNGLP + Deamidation(NQ); | −1.02 | 1014 |
| | Oxidation(HW) | | |
| 29 | NLRVPKP + Deamidation(NQ) | −1.01 | 1653 |
| 29 | PLTGWRVF + Oxidation(HW); Phospho(STY) | 0.34 | 1694 |
| 29 | FSTQERSGAP | −1.12 | 770 |
| 28 | HTDGTP | −1.68 | 757 |
| 27 | PGEVEP | −1.07 | 1338 |
| 27 | MHQPHQPLPPT + Oxidation(HW) | −1.35 | 1404 |
| 26 | QRNGQP + Deamidaiton(NQ) | −2.83 | 523 |
| 26 | PMGPAGLP | 0.24 | 1539 |
| 26 | LMPGPLR | 0.20 | 1780 |
| 26 | PAEDDNNNVATAPSTE + Deamidation(NQ); Phospho | −1.27 | 762 |
| | (STY) | | |
| 25 | ETTPFLT | −0.09 | 1366 |
| 24 | NQATRP + Deamidation(NQ) | −2.00 | 735 |
| 24 | PVPPPISG | 0.14 | 1898 |
| 24 | PSQTLSTCSVS | 0.38 | 841 |
| 24 | ALEWLGSIDTGGNT + Oxidation(HW); Phospho(STY) | −0.06 | 967 |
| 23 | PLPCSAP | 0.36 | 1579 |
| 23 | PSGPQCL | −0.23 | 1086 |
| 23 | HQPLPPT | −1.25 | 1718 |
| 23 | HKAADKVSA | −0.63 | 884 |
| 23 | PGPKLVKPSQ + Deamidation(NQ) | −0.93 | 1491 |
| 23 | LPLLP | 1.64 | 2500 |
| 23 | LPLIP | 1.78 | 2610 |
| 22 | MSINT + Oxidation(M) | 0.28 | 948 |
| 22 | FSLNT | 0.32 | 1108 |
| 22 | SLCPQ + Phospho(STY) | 0.08 | 996 |
| 22 | LMELPE | 0.15 | 1643 |
| 22 | LLLGRRAGPP | 0.02 | 1469 |
| 21 | EMPVPL + Oxidation(M) | 0.53 | 1867 |
| 21 | RRTTPP | −2.27 | 1263 |
| 21 | PRDGAES | −1.79 | 744 |
| 21 | PRDYT + Phospho(STY) | −2.32 | 1440 |
| 21 | PSQTLSLTCTVSN + Deamidation(NQ) | 0.09 | 806 |
| 21 | QSWMHQPHQPLPPT + Deamidation(NQ) | −1.43 | 1313 |
| 21 | FPGPI | 0.74 | 2172 |
| 21 | MPGPL + Oxidation(M) | 0.42 | 1792 |
| 20 | NIPMT + Deamidation(NQ) | 0.12 | 1464 |
| 20 | PFGSSA + Phospho(STY) | 0.17 | 1013 |
| 20 | PSSNILF + Deamidation(NQ) | 0.63 | 1533 |
| 20 | TGLWPINT + Oxidation(HW); Phospho(STY) | 0.06 | 1485 |
| 20 | QWGNHSGLSET + Deamidation(NQ) | −1.26 | 625 |
| 20 | PPVPGAMLLLLLGLL + Oxidation(M) | 1.93 | 1901 |
| 19 | DEENP + Deamidation(NQ) | −3.12 | 850 |
| 19 | HFIQML + Oxidation(M) | 1.05 | 1623 |
| 19 | DEDDLLPP | −1.20 | 1531 |
| 19 | HFNHIVEPSGPA | −0.38 | 1238 |
| 19 | LLDKMQGYVKEA | −0.38 | 1285 |
| 19 | YVSWFQQIPGSA + Deamidation(NQ); Oxidation(HQ); | 0.04 | 1368 |
| | Phospho(STY) | | |
| 19 | PFPGPI | 0.35 | 2247 |
| 18 | PQPDPAS | −1.54 | 1296 |
| 18 | YPFPIF + Phospho(STY) | 0.93 | 2730 |
| 18 | PQRGPVPGA | −0.84 | 1212 |
| 18 | SQLANLTQ + Phospho(STY) | −0.33 | 730 |
| 18 | PSRFSASRSG | −0.96 | 762 |
| 18 | PSRFSGSKDA | −1.17 | 889 |
| 18 | SVPPYRHGVSVV + Phospho(STY) | 0.22 | 1348 |
| 18 | PAQRPQRGLYQAD + Deamidation(NQ) | −1.58 | 1053 |
| 18 | ICRKKPCAHP | −0.74 | 1317 |
| 17 | LGPQNA + Deamidation(NQ) | −0.57 | 943 |
| 17 | KCQPPK + Deamidation(NQ) | −2.00 | 1357 |
| 17 | RIPSGCP | −0.27 | 1283 |
| 17 | ENMGGRP + Oxidation(M) | −1.71 | 741 |
| 17 | DRVKNF | −1.40 | 1183 |
| 17 | PNLWSAP | −0.40 | 1631 |
| 17 | AGEEPAGR | −1.29 | 739 |
| 17 | PNGVLEY | −0.33 | 1449 |
| 17 | TRKLACL + Phospho(STY) | 0.40 | 1177 |
| 17 | QGKCGPPPTI | −0.67 | 1267 |
| 17 | PRHLHALVGP | −0.09 | 1423 |
| 17 | KTGRAWYNPALK + Deamidation(NQ); Phospho(STY) | −1.11 | 1378 |
| 17 | EAQTLACPKEPCRECQ | −0.93 | 828 |
| 17 | LMPGPL | 0.98 | 1897 |
| 17 | SDIPNPI | −0.29 | 1679 |
| 16 | ASAPK + Sulfation(S) | −0.54 | 1124 |
| 16 | LITGLP | 1.57 | 1812 |
| 16 | LLASLP | 1.80 | 1775 |
| 16 | LRDLP | −0.40 | 1746 |
| 16 | SSNNI + Deamidation(NQ); Sulfation(S) | −0.82 | 606 |
| 16 | PGLQES | −1.00 | 922 |
| 16 | PNEDRT | −2.88 | 812 |
| 16 | SATVGFGS + Phospho(STY) | 0.71 | 699 |
| 16 | DHKNVRQ | −2.56 | 693 |
| 16 | DHQQKKL | −2.53 | 894 |
| 16 | PGEALTDPLP | −0.35 | 1496 |
| 16 | TARGFCQIVQ + Phospho(STY) | 0.32 | 901 |
| 16 | PRPGAPGALSPSYDGGLHG | −0.59 | 1132 |
| 15 | PSDPHT | −1.90 | 1127 |
| 15 | PGQSGKP | −1.74 | 954 |
| 15 | PTGVNAN | −0.53 | 780 |
| 15 | VLNMPP + Oxidation(M) | 0.53 | 1773 |
| 15 | NNPSPSA | −1.43 | 861 |
| 15 | PVTAGASV | 1.06 | 993 |
| 15 | PVQCDGP + Deamidation(NQ) | −0.56 | 1053 |
| 15 | KPSQTLS | −1.07 | 994 |
| 15 | HLARVPA | 0.33 | 1346 |
| 15 | PEIAGEW | −0.51 | 1489 |
| 15 | ELALPTPQE | −0.56 | 1361 |
| 15 | PLTGLWPIN + Deamidation(NQ); Oxidation(HW) | 0.38 | 1831 |
| 15 | EVLNNNPHI | −0.70 | 1191 |
| 15 | DHKKFFQM + Deamidaiton(NQ) | −1.31 | 1318 |
| 15 | QLLSNQILLP | 0.68 | 1510 |
| 15 | NGVATGTKIVTKGACI | 0.56 | 943 |
| 15 | EIAAEPTSSQHQDKV + Deamidation(NQ) | −0.25 | 1134 |
| 15 | LSLTCTVSGFSLSNYGV | 0.88 | 1011 |
| 15 | GGIPKTK | −0.91 | 1290 |
| 15 | IEDFKA | −0.30 | 1490 |
| 14 | PKPRL | −1.56 | 1978 |
| 14 | PSSNM + Phospho(STY) | −0.96 | 798 |
| 14 | DQPYR | −2.88 | 1332 |
| 14 | QHHCVP | −0.80 | 868 |
| 14 | HFSWE + Oxidation(HQ) | −1.12 | 1348 |
| 14 | HFDDTS | −1.48 | 785 |
| 14 | PFSTVVP | 0.93 | 1679 |
| 14 | WLPQGH + Oxidation(HW) | −0.97 | 1407 |
| 14 | RDPLPR | −1.98 | 1610 |
| 14 | PASIRCL | 0.81 | 1359 |
| 14 | PKGESKD | −2.51 | 964 |
| 14 | PPVPLTAP | 0.34 | 1970 |
| 14 | IPGMPGLP + Oxidation(M) | 0.58 | 1819 |
| 14 | WVGRPIP | −0.04 | 1947 |
| 14 | SPLFLGK + Phospho(STY) | 0.53 | 1664 |
| 14 | NPHHSQW + Deamidation(NQ); Oxidation(HW) | −2.39 | 936 |
| 14 | PPAPAEPRSA + Phospho(STY) | −0.98 | 1399 |
| 14 | RSTGVPSRFS + Phospho(STY) | −0.71 | 898 |
| 14 | IPGSEKAALGY + Phospho(STY) | 0.00 | 1312 |
| 14 | RINVAVTRAR + Phospho(STY) | −0.12 | 1043 |
| 14 | QIRTCRSTGSWS + Deamidation(NQ); Phospho(STY) | −0.88 | 694 |
| 14 | DMILDL + Oxidation(M) | 1.17 | 1698 |
| 13 | PPCGT + Phospho(STY) | −0.36 | 1136 |
| 13 | PGGSTP + Phospho(STY) | −0.92 | 953 |
| 13 | PHDQF | −1.80 | 1242 |
| 13 | VNISGGSF | 0.70 | 923 |
| 13 | PQRSLVSV | 0.13 | 1141 |
| 13 | HSSLPSST + Phospho(STY) | −0.61 | 768 |
| 13 | SKALHFE + Phospho(STY) | −0.43 | 1199 |
| 13 | PLQLQVEAP + Deamidation(NQ) | −0.01 | 1428 |
| 13 | PDRFSGSRCG | −1.12 | 735 |
| 13 | HMFMYFLR + Oxidation(M) | 0.53 | 1803 |
| 13 | IDGEWTSAPPI | −0.20 | 1498 |
| 13 | ACHPHPHLSF + Carbamidomethyl(C) | −0.27 | 1258 |
| 13 | PGIPP | −0.14 | 2166 |
| 13 | IPNPI | 0.46 | 2234 |
| 13 | IEVEL | 1.10 | 1636 |
| 13 | NQPMLP + Oxidation(M) | −0.75 | 1475 |
| 13 | LEMPLP + Oxidation(M) | 0.47 | 1988 |
| 13 | VEMPPE + Oxidation(M) | −0.68 | 1555 |
| 13 | RRQDVR | −2.72 | 720 |
| 12 | PQNAA | −1.00 | 794 |
| 12 | PQCAE | −0.86 | 760 |
| 12 | PLQSE | −1.12 | 1106 |
| 12 | QPGSQQ | −2.22 | 393 |
| 12 | PNDTPT | −1.93 | 1108 |
| 12 | SEMLAP | 0.27 | 1277 |
| 12 | TDGTSLP | −0.56 | 929 |
| 12 | TECQLP | −0.50 | 988 |
| 12 | PQRPAR | −2.32 | 1222 |
| 12 | VGGYQMS | −0.04 | 829 |
| 12 | PVAKPSF | 0.13 | 1693 |
| 12 | KFPPSDT | −1.33 | 1487 |
| 12 | KRPEHE | −3.37 | 1075 |
| 12 | IQKYKSLPKMS + Oxidation(M) | −0.86 | 1515 |
| 12 | PHGALQSE | −0.93 | 845 |
| 12 | LLEMQQT | −0.24 | 990 |
| 11 | DQGAHV + Deamidation(NQ); Oxidation(HW) | −0.77 | 560 |
| 11 | GSGAGQPV | −0.14 | 623 |
| 11 | SSDRFS | −1.27 | 673 |
| 11 | IIPMGIL | 2.46 | 2179 |
| 11 | TPGGPGGPE | −1.18 | 983 |
| 11 | VSVGLQTS | 0.75 | 778 |
| 11 | PLNMVPK | −0.10 | 1734 |
| 11 | HFSWEV | −0.23 | 1405 |
| 11 | NPHHLRA + Oxidation(HW) | −1.49 | 1070 |
| 11 | SGVPRHFS | −0.54 | 1034 |
| 11 | PVWSSATLPQC + Carbamidomethyl(C) | 0.16 | 1448 |
| 11 | VVGGLLI | 2.81 | 1599 |
| 11 | VAAALLL | 3.00 | 1591 |
| 11 | QCKFLP | 0.02 | 1515 |
| 11 | EVANPLL | 0.71 | 1489 |
| 11 | DALSSVQES | −0.34 | 661 |
| 11 | DIMITGLSK | 0.60 | 1353 |
| 11 | DTVFLDGSTLTFPSIQMA + Oxidation(M) | 0.28 | 1211 |
| 10 | SNSVD + Phospho(STY) | −0.88 | 460 |
| 10 | PFPQEG | −1.30 | 1390 |
| 10 | LPNPED | −1.65 | 1457 |
| 10 | GPIYGMT | 0.29 | 1457 |
| 10 | QPGQFTL | −0.44 | 1133 |
| 10 | PGRKAVHV | −0.43 | 1183 |
| 10 | PSLLTPQGP | −0.29 | 1453 |
| 10 | GPPAQAQETHN | −1.63 | 725 |
| 10 | SQRCINTHGSYKCL | −0.66 | 814 |
| 10 | QDVFVQ | 0.12 | 1062 |
| 9 | SKSTAA | −0.43 | 580 |
| 9 | QDPDE | −3.12 | 830 |
| 9 | AGEEPAG | −0.83 | 740 |
| 9 | VNHANT | −0.82 | 557 |
| 9 | HRTPCA | −0.95 | 837 |
| 9 | VSWVRQ + Oxidation(HW) | −0.22 | 1175 |
| 9 | EEFPLGP | −0.57 | 1630 |
| 8 | GNNDPAG | −1.59 | 553 |
| 8 | PVDGHAL | 0.16 | 1214 |
| 8 | WGQGLR | −0.98 | 1008 |
| 8 | PQKAVPY | −0.84 | 1704 |
| 8 | PQALASLC | 0.98 | 1108 |
| 8 | YPRKEI | −1.72 | 1873 |
| 8 | TVMFPPQ | 0.21 | 1603 |
| 8 | VLGSLLPGEP | 0.73 | 1478 |
| 8 | KIAQMLPGVG | 0.64 | 1313 |
| 8 | PIQYVLSRY | −0.06 | 1790 |
| 8 | LPLP | 1.10 | 2520 |
| 8 | IPIP | 1.45 | 2795 |
| 8 | IPLP | 1.275 | 2658 |
| 8 | LPIP | 1.28 | 2658 |
| 8 | DFLP | 0.38 | 2058 |
| 8 | DFIP | 0.55 | 2195 |
| 8 | DAPFR | −1.00 | 1454 |
| 8 | WGPTPLP | −0.43 | 1960 |
| 7 | LLLVI | 4.02 | 2384 |
| 7 | PQGKSD | −2.28 | 767 |
| 7 | PRPPSPIST | −0.97 | 1633 |
| 7 | QREHAASVP | −1.03 | 832 |
| 7 | PDRFSGTKS | −1.49 | 951 |
| 7 | HLAPAP | 0.17 | 1603 |
| 7 | DFPEAR | −1.42 | 1303 |
| 6 | NGCVTGH | −0.21 | 374 |
| 6 | PGTLAHSGVYR | −0.28 | 1095 |
| 6 | LDFP | 0.38 | 2058 |
| 6 | VSMRL | 0.92 | 1236 |
| 6 | QANLWCLSRCA | 0.27 | 905 |
| 5 | PGSPGLV | 0.46 | 1341 |
| 5 | LPPT | −0.03 | 2025 |
| 5 | MKTP + Oxidation(M) | −1.08 | 1465 |
| 5 | DFILLN | 1.32 | 1832 |
| 5 | FDLPGVS | 0.64 | 1423 |
| 5 | PSNVLSPTP | −0.29 | 1387 |
| 4 | HLPLP | 0.24 | 2116 |
| 4 | GRKDT | −2.60 | 642 |
| 4 | TQPINQATGGPK | −1.13 | 926 |
| 3 | CMKVSISLTVG | 1.32 | 1099 |
| 3 | YAVGWVRQAPG | −0.05 | 1269 |
| 3 | QTAVL | 1.12 | 1036 |
| 3 | EIPLP | 0.32 | 2236 |
| 3 | LEPLP | 0.18 | 2126 |
| 3 | IQSLPGIP | 0.61 | 1693 |
| 3 | QQKYPEKQDT | −2.89 | 972 |
| 2 | MGSVTPEDT | −0.57 | 847 |
| 2 | HQPLPPTVM + Oxidation(M) | −0.26 | 1568 |
| 2 | DGAHRNDDET | −2.45 | 456 |
| 2 | DILTVT | 1.27 | 1417 |
| 1 | LRLFPQIKG | 0.11 | 1690 |
| 1 | HRGMYRCQV + Carbamidomethyl(C) | −0.98 | 858 |
| 1 | TNTTRQGLQIEVTV | −0.36 | 829 |
| 1 | DSELPT | −1.05 | 1102 |
| 1 | LPPLTIQ | 0.67 | 1913 |
| 1 | DLEQGPAP | −1.06 | 1173 |

VTP15 only consists of the peptides listed in Table 3. Nutramigen™ (VTP3) comprises, further to the peptides listed in Table 3, the following ingredients: glucose syrup, vegetable oil (palm olein oil, coconut oil, soybean oil, high oleic sunflower oil), modified corn starch, <2%, calcium phosphate <1%, calcium citrate, potassium citrate, potassium chloride, L-Cystine, choline chloride, L-tyrosine, inositol, magnesium oxide, L-tryptophan, ascorbic acid, ferrous sulfate, taurine, L-carnitine, DL-alpha-tocopheryl acetate, zinc sulfate, nicotinamide, calcium pantothenate, cupric sulfate, retinyl palmitate, manganese sulfate, thiamine hydrochloride, riboflavin, pyridoxine hydrochloride, sodium iodide, folic acid, phytomenadione, sodium molybdate, chromic chloride, cholecalciferol, sodium selenite, biotin, cyanocobalamin.

A further preferred embodiment of the disclosure relates to the nutritional formulation of the disclosure, wherein the human subject is a child or juvenile.

The term “child” or the term “juvenile” is used herein in accordance with the definitions provided in the art. Thus, the term “child” means a human subject between the stages of birth and the age of about 10 and the term “juvenile” means a human subject between the age of about 10 and puberty (before sexual maturity).

The disclosure relates in a further preferred embodiment to the nutritional formulation of the disclosure, wherein the human subject is an adult.

The term “adult” is used herein in accordance with the definitions provided in the art. Thus, this term means a human subject after puberty (after sexual maturity).

A further preferred embodiment of the disclosure relates to the nutritional formulation of the disclosure, wherein the human subject has a cow's milk allergy.

The term “cow's milk allergy” describes a food allergy, i.e. an immune adverse reaction to one or more of the proteins contained in cow's milk in a human subject. The principal symptoms are gastrointestinal, dermatological and respiratory symptoms. These can translate into skin rashes, hives, vomiting, diarrhea, constipation and distress. The clinical spectrum extends to diverse disorders: anaphylactic reactions, atopic dermatitis, wheeze, infantile colic, gastro esophageal reflux disease (GERD), esophagitis, colitis gastroenteritis, headache/migraine and constipation.

In another preferred embodiment of the nutritional formulation of the disclosure, the nutritional formulation additionally comprises one or more of carbohydrates, nucleic acids, lipids, minerals, anabolic nutrients, vitamins, antioxidants, probiotic bacterial strains and lipotropic agents.

These additional compounds of the nutritional formulation of the disclosure are preferably added in order to provide the nutritional value of the nutritional formulation described herein above. Also they may be preferably added in order provide complete nutrition, an optimal sustained energy and/or an anabolic nutritional formulation.

Non-limiting examples of lipids that may be provided in the nutritional formulation include coconut oil, soy oil, and mono- and diglycerides. Exemplary carbohydrates are, for example, glucose, edible lactose and hydrolyzed cornstarch. Non-limiting examples of minerals and vitamins are calcium, phosphorous, potassium, sodium, chloride, magnesium, manganese, iron, copper, zinc, selenium, iodine, and Vitamins A, E, D, C, and the B complex, respectively. Probiotic bacterial strains include, for example, lactic acid bacteria (LAB) and Bifidobacteria. Examples of antioxidants include natural antioxidants such as ascorbic acid (AA, E300) and tocopherols (E306), as well as synthetic antioxidants such as propyl gallate (PG, E310), tertiary butylhydroquinone (TBHQ), butylated hydroxyanisole (BHA, E320) and butylated hydroxytoluene (BHT, E321). Non-limiting examples of nucleic acids are deoxyribonucleic acid (DNA) and ribonucleic acid (RNA).

A further preferred embodiment of the disclosure relates to the nutritional formulation of the disclosure, wherein the tolerance is induced transiently.

The term “transient” induction of tolerance in accordance with the disclosure relates to a immunological tolerance that is induced for a limited period of time upon intake of the nutritional formulation of the disclosure by a human subject, which preferably is a human subject having a cow's milk allergy or having the risk of developing a cow's milk allergy. In this regard, a transient period of time specifies that the human subject does not gain constant tolerance.

Transient tolerance preferably relates to tolerance induced for at least half a day, such as for at least one day, such as for at least two days, preferably for at least one week, more preferably for at least two weeks, even more preferably for at least one month and most preferably for at least 3 months. In accordance with the disclosure transient tolerance is induced for less than 6 months.

The Examples illustrate the disclosure.

### Example 1

### Experimental Procedures

Biological Materials and Patients

Milk samples named VTP1-VTP16 were obtained from different suppliers and contained whole cow's milk protein, partially hydrolyzed, extensively hydrolyzed and amino acids formulations. cDNA coding for αS1-casein (rαS1-cas) was isolated by IgE immunoscreening from a cDNA expression library prepared from bovine mammary glands (Schulmeister et al., J. Immunol. 2009). Recombinant allergens were expressed in Escherichia coli strain BL21 Codon Plus (DE3)-RIPL (Stratagene, La Jolla, Calif.) as hexahistidine-tagged proteins and purified by Ni²⁺ affinity chromatography (QIAGEN, Hilden, Germany). Recombinant Bet v1a was purchased from Biomay (Vienna, Austria).

Pasteurized cow's milk containing 3.5% fat was bought at a local market (NOM, Austria, batch: 22 550 2:00) and natural cow's milk proteins were purchased from Sigma-Aldrich (Vienna, Austria).

Rabbit sera were obtained by immunizing rabbits three times with purified rαS1-cas, rαS2-cas, rβ-cas, rκ-cas, rα-la, rβ-lg, and rlf (Charles, River, Kissleg, Germany).

Cow's milk allergic patients were selected according to a positive case history, positive skin-prick reactions or determination of specific IgE to cow's milk extract using the ImmunoCAP System (Phadia, Uppsala, Sweden).

Persons without any problems after milk consumption were recruited as controls. They comprised non-allergic as well as patients with IgE-mediated allergy to allergen sources other than milk.

Table 4 provides demographic, clinical and serological characterization of individuals analyzed in the proliferation assays.

TABLE 4

| | | | | | Mix-related | Other | Total IgE | CM (kUA/I) |
|---|---|---|---|---|---|---|---|---|
| | Patient | Age | Sex | Country | symptoms | allergies | (kU/l) | or SFT |
| non- | MC | 51 y | f | A | no | no | 6.16 | <0.35 |
| allergic | AG | 20 y | f | A | no | no | 81.9 | <0.35 |
| | AB | 21 y | m | A | no | no | 6.89 | <0.35 |
| | FK | 42 y | m | A | no | no | 27 | <0.35 |
| | VC | 50 y | f | A | no | no | nd | nd |
| | KFI | 24 y | f | A | no | no | 29.8 | nd |
| CMA | ES | 22 y | f | A | Sys | PO, cat, dog, hen's egg, | 3350 | 235.8 |
| | | | | | | mite, hazelnut | | |
| | VW | 24 y | f | A | GI | PO | 456 | 6.25 |
| | RD | 49 y | m | A | AD, asthma | mite | 146 | 2.80 |
| | KK | 6 y | f | A | AD, Sys | PO, hen's egg, soy, | 2528 | 82.5 |
| | | | | | | mite, moulds, nuts | | |
| | GE | 31 y | m | A | AD, Sys | moulds, dog | 118 | <0.36, SPT |
| | GM | 5 y | m | A | na | na | nd | 0.76 |
| | NL | 4 y | f | A | na | na | nd | nd |

^{a}Abbrevations used in the figure: y, years: f, female: m, male:A, Austria, Symptoms: Sys, systemic reactions: Gt, Gastrointestinal symptoms: AD, atopic dermatisis; Allergen (source): PO, pollen: kU/l, total IgE in kilo units/liter; kUA/L, allengen-specific IgE in kilo units antigen/liter; CM, cow's milk: SPT, skin-pick test: na, not applicable; nd, not done.

Table 5 shows proliferation assays that were performed with PBMCs to test the T-cell reactivity to the milk samples VTP1-VTP16. PBMCs from six non-allergic individuals and from seven cow's milk allergic patients were stimulated with milk samples, with cow's milk allergens (rαS1-casein, rαS2-casein, nα-casein), with αS1-casein-derived peptides (αS1-peptide 1-αS1-peptide 6), with birch pollen allergen, rBet v 1a, and grass pollen allergen, Phl p 5-peptide 1. Concentrations used for stimulation: milk sample: 10 pg/well; proteins: 5 pg/well; peptides: 1.6 pg/well; and peptide mix: 0.26 pg per peptide/well. In Table 5, “nd” means “not done” and “max SI” means “maximal stimulation index with IL-2. Stimulation indices are displayed in Table 5, and all stimulation indices greater than or equal to 2 are highlighted.

TABLE 5

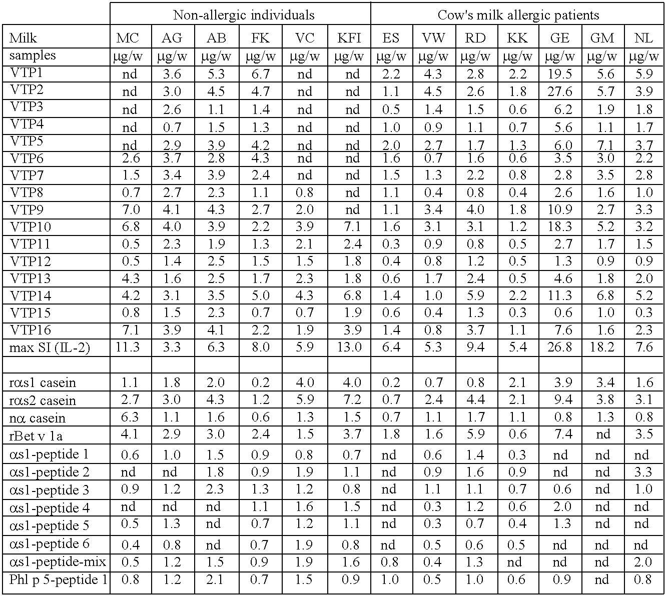

Characterization of the Milk Samples

The composition of the milk samples VTP1-VTP16 was assessed by SDS-PAGE and Coomassie Brilliant Blue staining (Biorad, Hercules, Calif.).

For immunoblot analysis lug aliquots of VTP1-VTP16 were dotted onto a nitrocellulose membrane (Schleicher & Schuell, Dassel, Germany). The nitrocellulose strips were blocked with PBST (PBS, 0.5% v/v Tween 20) and exposed to sera from milk allergic patients, healthy individuals or rabbit antisera diluted 1:10, 1:20 or 1:2000 in over night at 4° C. Bound human IgE antibodies were detected with ¹²⁵I-labelled anti-human IgE antibodies (IBL, Hamburg, Germany), diluted 1:15 or bound rabbit IgG with ¹²⁵I-labelled anti-rabbit IgG (Perkin Elmer, USA) diluted 1:2000 in PBST and visualized by autoradiography using Kodak XOMAT films with intensifying screens (Kodak, Austria) at −80° C.

Endotoxin levels of the milk samples used in this study were quantified by limulus amoebocyte lysate assay (Lonza, Basel, Switzerland) with a sensitivity range of 0.1 EU/ml-1.0 EU/ml according to the manufacturer's instructions.

Rat Basophil Leukaemia (RBL) Assays

For the quantification of IgE antibody-mediated, immediate-type reactions, huRBL cell mediator release assays were performed as described previously (Schulmeister et al., J. Immunol. 2009, Vol 182(11), pp 7019-29). In brief, RBL cells (clone RBL-703/21) transfected with the human FccRI receptor were incubated with sera from cow's milk allergic patients overnight. On the next day the cells were washed, 100 μl of milk components (concentration: 0.3 μg/ml) were added and incubated for 1 hour at 37° C., 7% CO₂, 95% humidity. Aliquots of the supernatants were mixed with assay solution (0.1 M citric acid or sodium citrate, pH 4.5+160 μM 4-methyl umbelliferyl-N-acetyl-β-D-glucosamide) and incubated for 1 hour at 37° C., 7% CO₂, 95% humidity. Fluorescence was measured with a fluorescence microplate reader and specific release could be calculated. Values obtained with buffer alone were subtracted and the values exceeded 5% of total release were considered as positive.

Cell Preparation and Lymphoproliferative Assays

PBMCs from non-allergic individuals and cow's milk allergic patients were separated from heparinized blood by Ficoll density-gradient centrifugation (GE Healthcare, Uppsala, Sweden). PBMCs (2×10⁵ cells per well) were cultured in triplicates in 96-well plates (Nunclone; Nalgen Nunc International, Roskilde, Denmark) in 200 μl serum-free Ultra Culture medium (UltraCulture, Lonza, Verviers, Belgium) supplemented with 2 mM L-glutamine (GIBCO, Auckland, NZ), 50 μM b-mercaptoethanol (GIBCO), and 0.1 mg/ml gentamicin (GIBCO). The cells were incubated at 37° C. in a humidified atmosphere with 5% CO₂ for 7 days with or without different concentrations of various hydrolyzed samples. Cells were stimulated with different concentrations, 4U IL-2 per well (Roche, Mannheim, Germany) served as a positive control and medium alone served as a negative control. After 6 days of incubation, 0.5 mCi 3H-thymidine (GE Healthcare) was added to each well for 16 h then the incorporated radioactivity was measured by liquid scintillation counting. Proliferation was expressed as counts per minute (c.p.m.; means of triplicates) using a microbeta scintillation counter (Wallac ADL, Freiburg, Germany). The stimulation index (SI) was calculated as quotient of c.p.m. with antigen and the medium control.

Analysis of Cytokine Levels in Supernatants

Cytokine levels (IL-2, IL-4, IL-5, IL-6, IL-10, IL-12, IL-13, IFN-γ, TNF-α, GM-CSF, TGF-β1, TGF-β2, and TGF-β3) were measured in supernatants collected from PBMC cultures at day 6 of culture using xMAP Luminex fluorescent bead-based technology (Luminex Corp., Austin, Tex.). The assays were performed according to the manufacturer's instructions (R&D Systems, Wiesbaden, Germany), and fluorescent signals were read on a Luminex 100 system (Luminex Corp.). The limits of detection were 3.2 pg/ml for IL-2, 3.5 pg/ml for IL-4, 1.9 pg/ml for IL-5, 5.5 pg/ml for IL-6, 3.1 pg/ml for IL-10, 57 pg/ml for IL-12, 47 pg/ml for IL-13, 2.9 pg/ml for IFN-γ, 5.3 pg/ml for TNF-α, 3.3 pg/ml for GM-CSF, 21 pg/ml for TGF-β1, 178 pg/ml for TGF-β2, and 5 pg/ml for TGF-β3.

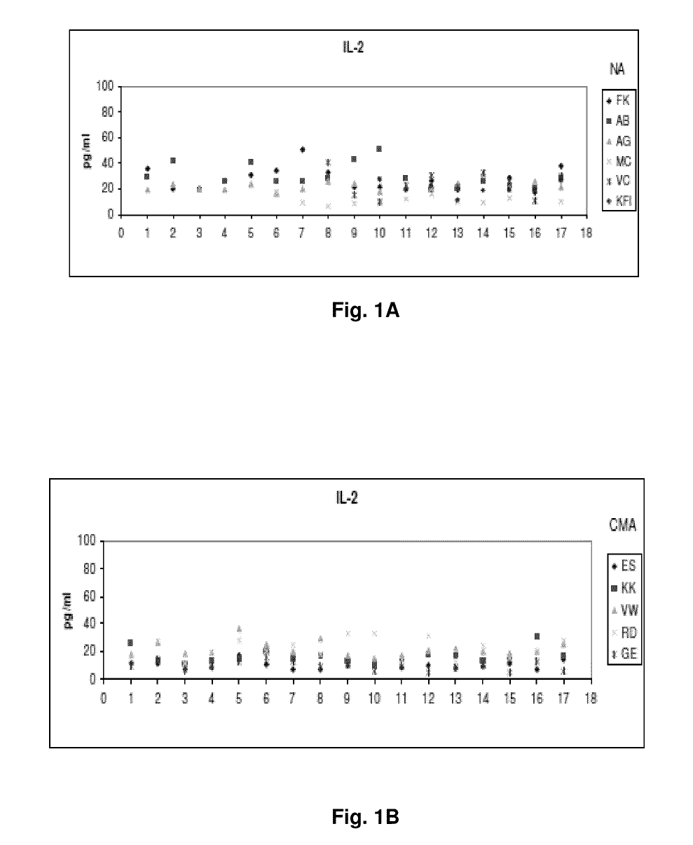

FIGS. 1-13 illustrate the luminex-analyses that were performed in the supernatants of PBMCs in order to analyze which cytokines are induced in PBMCs by the different milk samples (VTP1-VTP16). Analysis of cytokine levels (y-axis: pg/ml) in supernatants of PBMC cultures from 6 non-allergic individuals (NA) and 5 cow's milk allergic patients (CMA) which had been stimulated with milk samples VTP1-VTP16 (1-16) or medium (17) are displayed. Fluorescent signals were read on a Luminex 100 system.

More specifically, FIG. 1A illustrates levels of interleukin 2 (IL-2) measured in supernatant collected from PBMC cultures from six non-allergic individuals at day six of culture using xMAP Luminex fluorescent bead-based technology. The range of detection was 3.2-2350 pg/ml.

FIG. 1B illustrates levels of IL-2 measured in supernatant collected from peripheral blood mononuclear cell (PBMC) cultures from five cow's milk allergic patients at day six of culture using xMAP Luminex fluorescent bead-based technology. The range of detection was 3.2-2350 pg/ml.

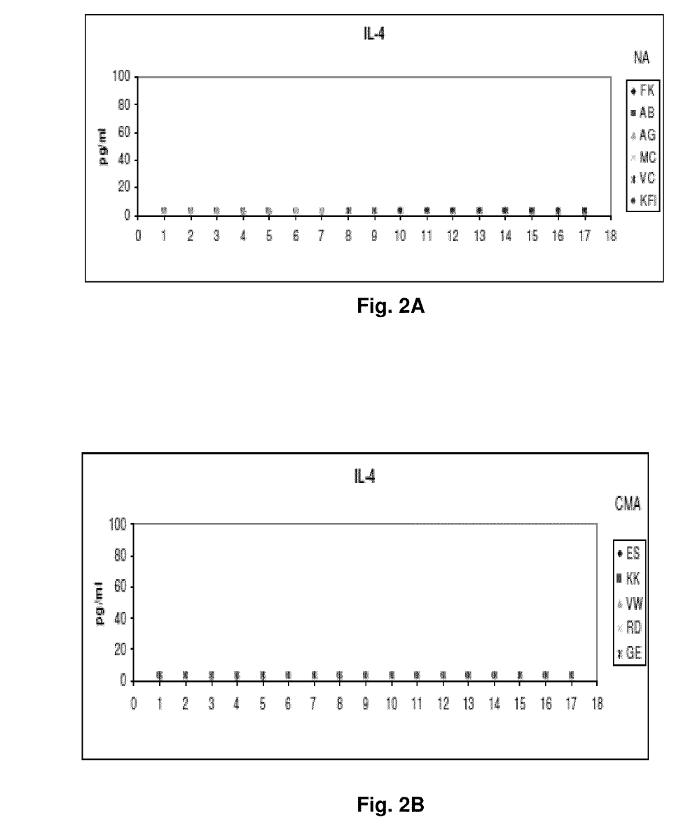

FIG. 2A illustrates levels of interleukin 4 (IL-4) measured in supernatant collected from PBMC cultures from six non-allergic individuals at day six of culture using xMAP Luminex fluorescent bead-based technology. The range of detection was 3.5-2575 pg/ml.

FIG. 2B illustrates levels of IL-4 measured in supernatant collected from PBMC cultures from five cow's milk allergic patients at day six of culture using xMAP Luminex fluorescent bead-based technology. The range of detection was 3.5-2575 pg/ml.

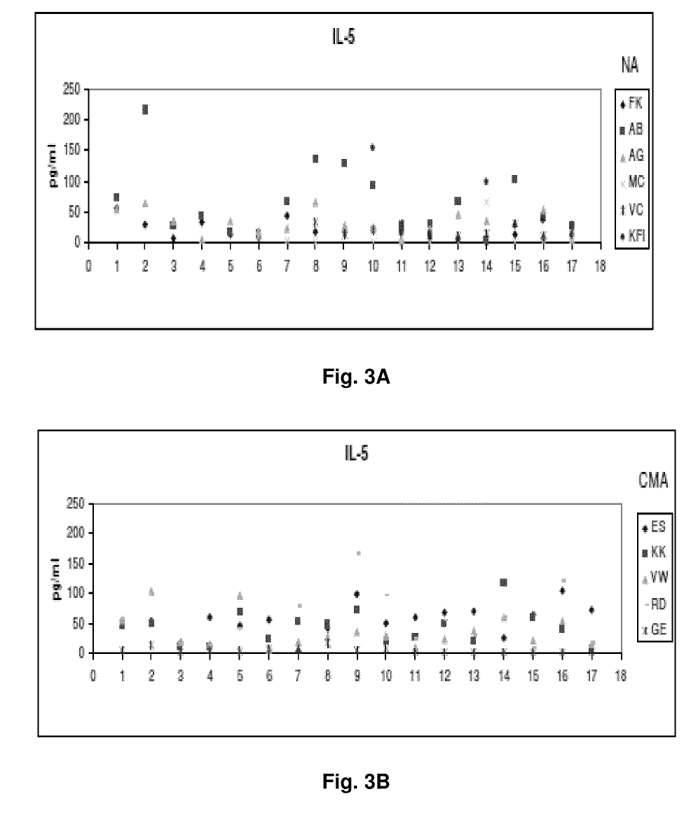

FIG. 3A illustrates levels of interleukin 5 (IL-5) measured in supernatant collected from PBMC cultures from six non-allergic individuals at day six of culture using xMAP Luminex fluorescent bead-based technology. The range of detection was 1.9-1400 pg/ml.

FIG. 3B illustrates levels of IL-5 measured in supernatant collected from PBMC cultures from five cow's milk allergic patients at day six of culture using xMAP Luminex fluorescent bead-based technology. The range of detection was 1.9-1400 pg/ml.

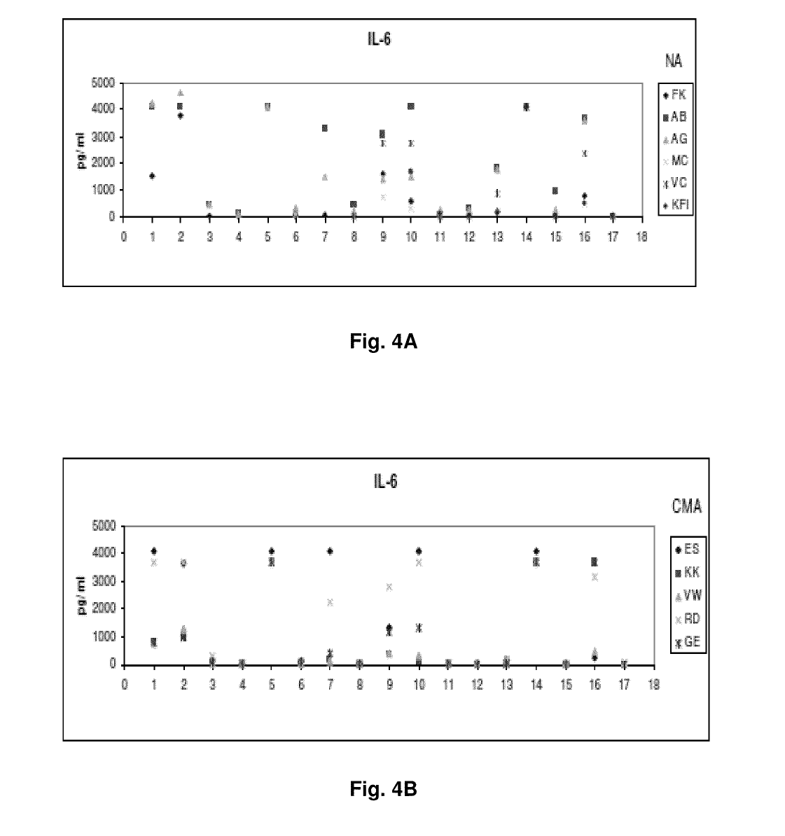

FIG. 4A illustrates levels of interleukin 6 (IL-6) measured in supernatant collected from PBMC cultures from six non-allergic individuals at day six of culture using xMAP Luminex fluorescent bead-based technology. The range of detection was 5.5-4000 pg/ml.

FIG. 4B illustrates levels of IL-6 measured in supernatant collected from PBMC cultures from five cow's milk allergic patients at day six of culture using xMAP Luminex fluorescent bead-based technology. The range of detection was 5.5-4000 pg/ml.

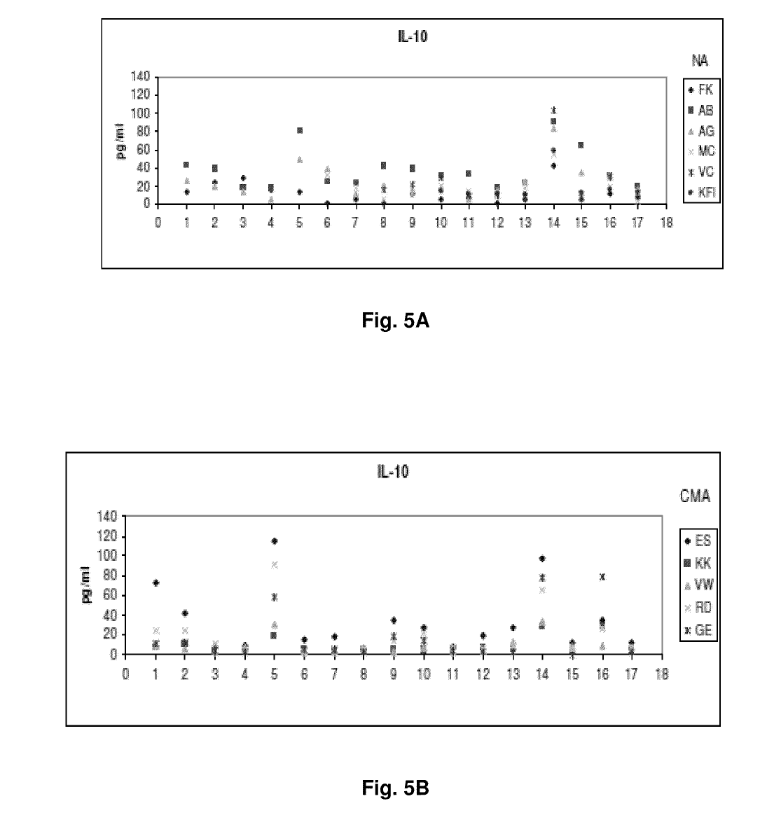

FIG. 5A illustrates levels of interleukin 10 (IL-10) measured in supernatant collected from PBMC cultures from six non-allergic individuals at day six of culture using xMAP Luminex fluorescent bead-based technology. The range of detection was 3.1-2250 pg/ml.

FIG. 5B illustrates levels of IL-10 measured in supernatant collected from PBMC cultures from five cow's milk allergic patients at day six of culture using xMAP Luminex fluorescent bead-based technology. The range of detection was 3.1-2250 pg/ml.

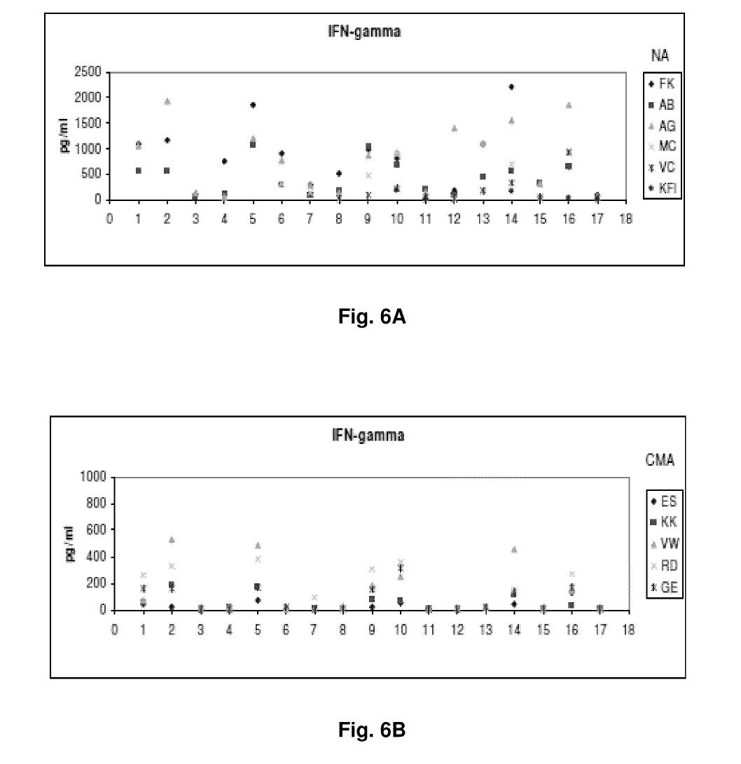

FIG. 6A illustrates levels of interferon-gamma (IFN-gamma) measured in supernatant collected from PBMC cultures from six non-allergic individuals at day six of culture using xMAP Luminex fluorescent bead-based technology. The range of detection was 2.9-2100 pg/ml.

FIG. 6B illustrates levels of IFN-gamma measured in supernatant collected from PBMC cultures from five cow's milk allergic patients at day six of culture using xMAP Luminex fluorescent bead-based technology. The range of detection was 2.9-2100 pg/ml.

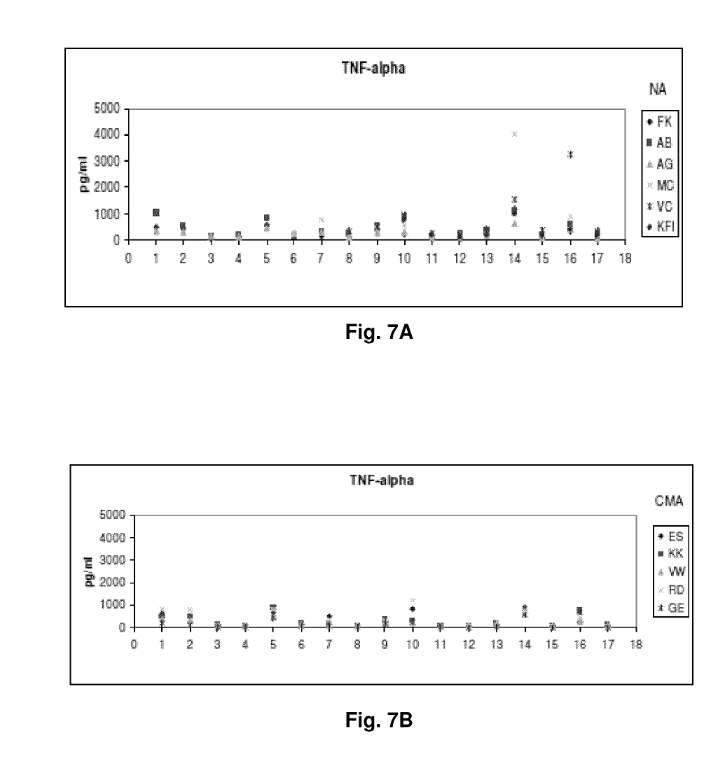

FIG. 7A illustrates levels of tumor necrosis factor-alpha (TNF-alpha) measured in supernatant collected from PBMC cultures from six non-allergic individuals at day six of culture using xMAP Luminex fluorescent bead-based technology. The range of detection was 5.3-3900 pg/ml.

FIG. 7B illustrates levels of TNF-alpha measured in supernatant collected from PBMC cultures from five cow's milk allergic patients at day six of culture using xMAP Luminex fluorescent bead-based technology. The range of detection was 5.3-3900 pg/ml.

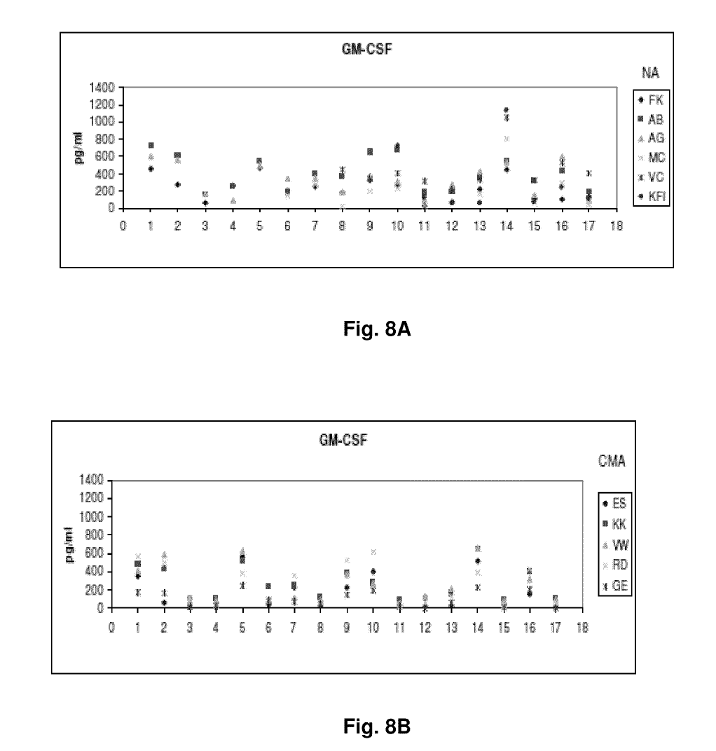

FIG. 8A illustrates levels of granulocyte macrophage colony stimulating factor (GM-CSF) measured in supernatant collected from PBMC cultures from six non-allergic individuals at day six of culture using xMAP Luminex fluorescent bead-based technology. The range of detection was 3.3-2400 pg/ml.

FIG. 8B illustrates levels of GM-CSF measured in supernatant collected from PBMC cultures from five cow's milk allergic patients at day six of culture using xMAP Luminex fluorescent bead-based technology. The range of detection was 3.3-2400 pg/ml.

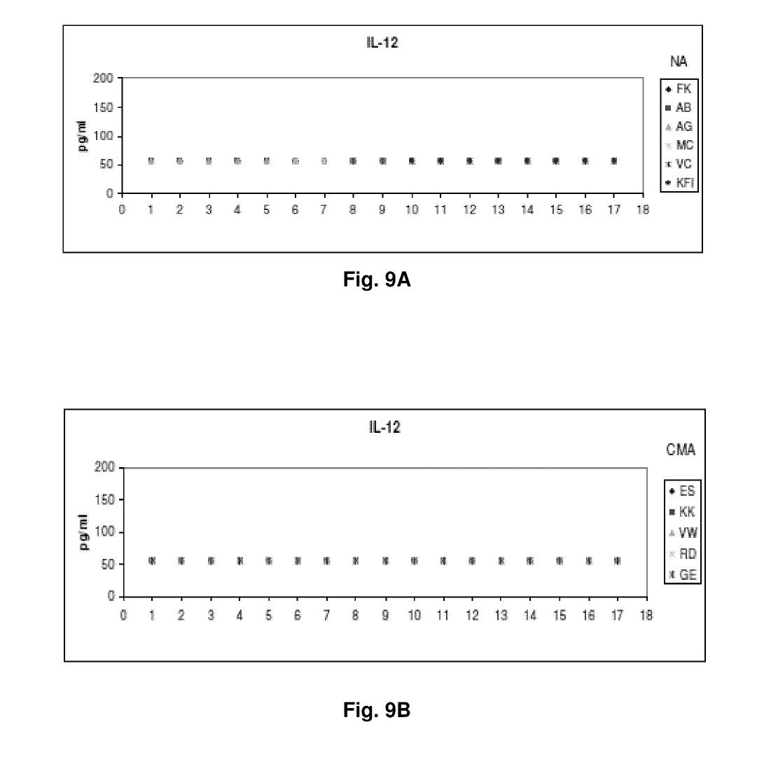

FIG. 9A illustrates levels of interleukin 12 (IL-12) measured in supernatant collected from PBMC cultures from six non-allergic individuals at day six of culture using xMAP Luminex fluorescent bead-based technology. The range of detection was 57-41500 pg/ml.

FIG. 9B illustrates levels of IL-12 measured in supernatant collected from PBMC cultures from five cow's milk allergic patients at day six of culture using xMAP Luminex fluorescent bead-based technology. The range of detection was 57-41500 pg/ml.

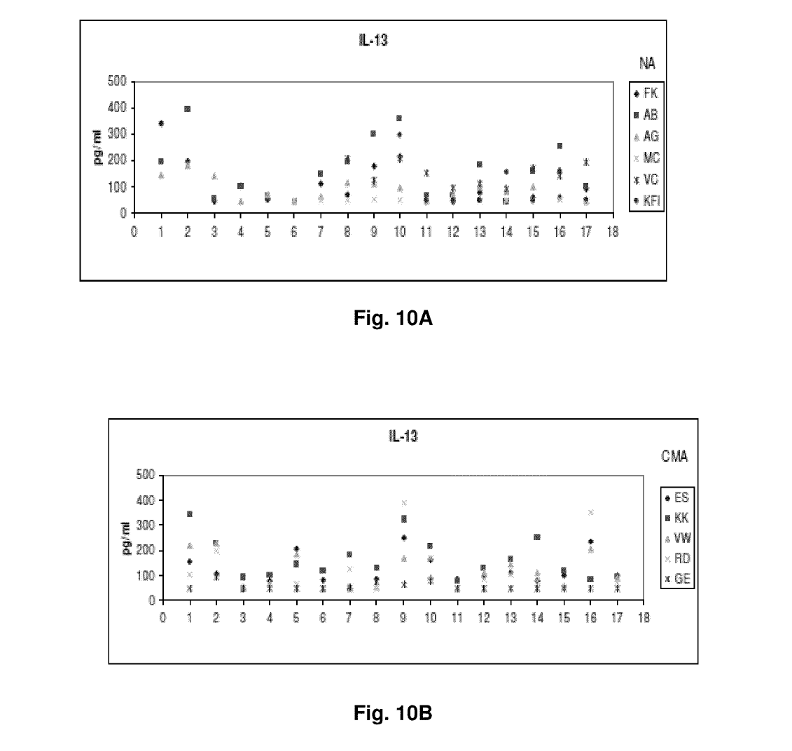

FIG. 10A illustrates levels of interleukin 13 (IL-13) measured in supernatant collected from PBMC cultures from six non-allergic individuals at day six of culture using xMAP Luminex fluorescent bead-based technology. The range of detection was 47-34500 pg/ml.

FIG. 10B illustrates levels of IL-13 measured in supernatant collected from PBMC cultures from five cow's milk allergic patients at day six of culture using xMAP Luminex fluorescent bead-based technology. The range of detection was 47-34500 pg/ml.

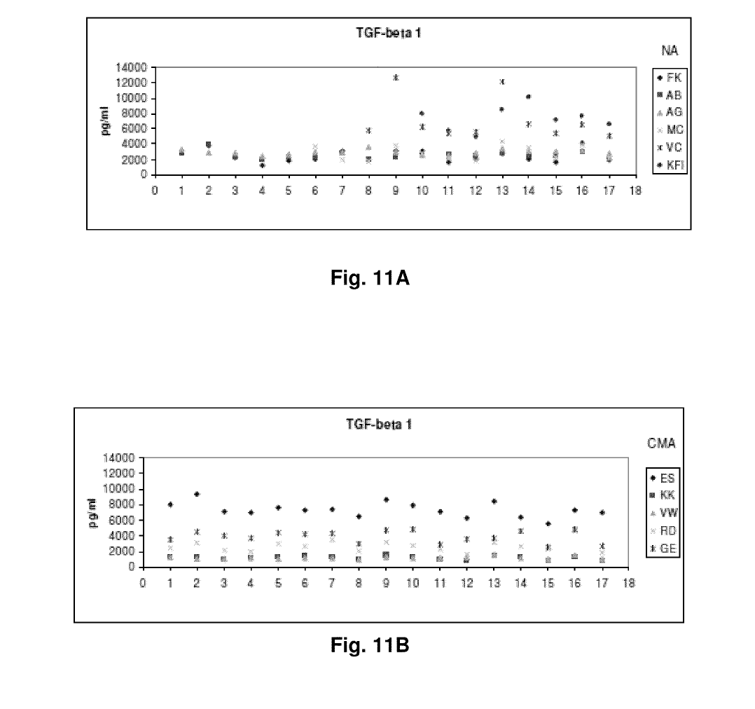

FIG. 11A illustrates levels of transforming growth factor beta 1 (TGF-β1) measured in supernatant collected from PBMC cultures from six non-allergic individuals at day six of culture using xMAP Luminex fluorescent bead-based technology. The range of detection was 33.3-24300 pg/ml.

FIG. 11B illustrates levels of TGF-β1 measured in supernatant collected from PBMC cultures from five cow's milk allergic patients at day six of culture using xMAP Luminex fluorescent bead-based technology. The range of detection was 33.3-24300 pg/ml.

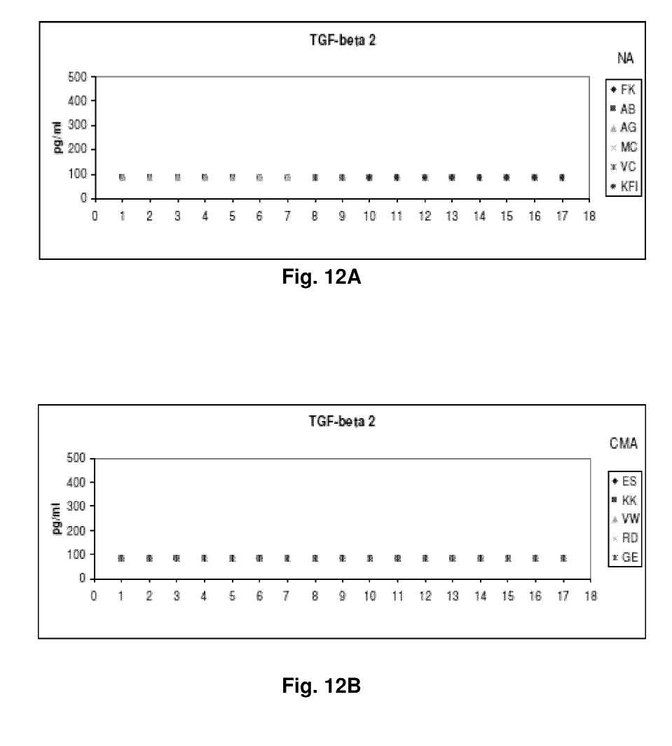

FIG. 12A illustrates levels of transforming growth factor beta 2 (TGF-β2) measured in supernatant collected from PBMC cultures from six non-allergic individuals at day six of culture using xMAP Luminex fluorescent bead-based technology. The range of detection was 17.1-12500 pg/ml.

FIG. 12B illustrates levels of TGF-β2 measured in supernatant collected from PBMC cultures from five cow's milk allergic patients at day six of culture using xMAP Luminex fluorescent bead-based technology. The range of detection was 17.1-12500 pg/ml.

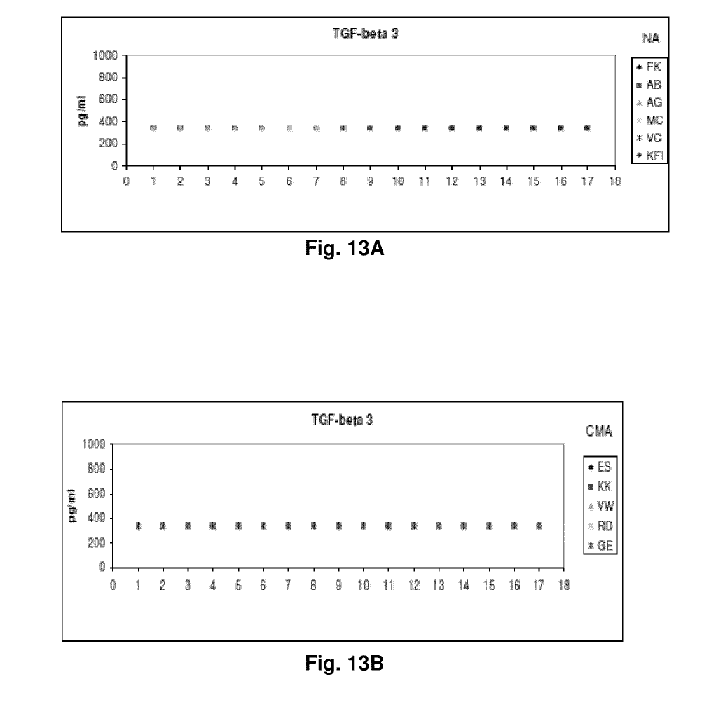

FIG. 13A illustrates levels of transforming growth factor beta 3 (TGF-β3) measured in supernatant collected from PBMC cultures from six non-allergic individuals at day six of culture using xMAP Luminex fluorescent bead-based technology. The range of detection was 68.3-49850 pg/ml.

FIG. 13B illustrates levels of TGF-β3 measured in supernatant collected from PBMC cultures from five cow's milk allergic patients at day six of culture using xMAP Luminex fluorescent bead-based technology. The range of detection was 68.3-49850 pg/ml.

Tolerance Induction Experiments

For the tolerance induction experiment, PBMCs from healthy donors were isolated by Ficoll-density gradient, and the cells were further separated into two fractions. T-cells were enriched with a human Pan-T-cell isolation Kit (Miltenyi, Bergisch Gladbach, Germany), whereas antigen-presenting cells were enriched with human CD3 MicroBeads (Miltenyi, Bergisch Gladbach, Germany) by magnetic cell sorting. The purity of the cell fractions was confirmed by FACS analysis.

The cell fractions containing the T-cells were incubated overnight with different peptides or medium alone at 37° C. with 5% CO₂ and 95% humidity, the antigen-presenting-cell fractions were kept overnight at the same conditions without any antigens. On the next day, the T-cell fractions were washed with DPBS (GIBCO) three times and the T-cell and antigen-presenting-cell fractions were combined. The cells (2×10⁵ cells per well) were cultured in triplicates in 96-well plates as described above. Cells were stimulated with different concentrations of milk samples, 4U IL-2 per well, or medium alone. The analysis was done as described for the lymphoproliferative assays.

Table 6 shows a tolerance experiment with a non-allergic individual (KF1) evaluating milk hydrolysates for their ability to tolerize T cells. T-cell fractions were preincubated over night with high amounts of Nutramigen™ base (VTP11), extensive casein hydrolysate (VTP15), whole cow's milk whey protein (VTP14), Nutramigen™ (VTP3), synthetic peptides (αS1-casein peptide 4 and a control peptide, Phl p 5-Pep 1) or buffer (UCO). On the next day the T-cells and the APCs were combined and stimulated with milk samples (VTP14, VTP1). T cell stimulation is given either in counts per minute (cpm) or as stimulation index (SI). Cpms of individual experiments and the means thereof are displayed.

TABLE 6

| | tolerized with: UCO | | | | |
|---|---|---|---|---|---|
| stimulated with: | cpm | cpm | cpm | mean | SI |
| UCO | 15631 | 12705 | 20391 | 16242 | |
| VTP14 | 29468 | 43062 | 38634 | 37055 | 2.3 |
| VTP14 | | 3886 | 7349 | 5618 | 0.3 |
| VTP1 | 11394 | 10441 | 4824 | 8886 | 0.5 |
| VTP1 | 4201 | 5674 | 7161 | 5679 | 0.3 |
| IL-2 | 16371 | 12600 | | 14486 | 0.9 |
| | tolerized with: Ph1 p 5-Pep 1, 3 μg/w | | | | |
| stimulated with: | cpm | cpm | cpm | mean | SI |
| UCO | 11263 | 13457 | 12846 | 12522 | |
| VTP14 | 38430 | 45751 | 41730 | 41970 | 3.4 |
| VTP14 | 3282 | 2244 | 1482 | 2336 | 0.2 |
| VTP1 | 4708 | 3278 | 4898 | 4295 | 0.3 |
| VTP1 | 6315 | 6342 | 6409 | 6355 | 0.5 |
| IL-2 | 14153 | 17806 | 12214 | 14724 | 1.2 |
| | tolerized with: αS2-PEP 4, 3 μg/w | | | | |
| stimulated with: | cpm | cpm | cpm | mean | SI |
| UCO | 17694 | 14608 | | 16151 | |
| VTP14 | | 16162 | 25246 | 20794 | 1.3 |
| VTP14 | | 2790 | 4703 | 3747 | 0.2 |
| VTP1 | 6381 | 6304 | 6226 | 6304 | 0.4 |
| VTP1 | 8231 | 8478 | 3154 | 6621 | 0.4 |
| IL-2 | 12704 | 19463 | 11433 | 14533 | 0.9 |
| | tolerized with: VTP 11, 15 μg/w | | | | |
| stimulated with: | cpm | cpm | cpm | mean | SI |
| UCO | 7007 | 6020 | | 6514 | |
| VTP14 | 23156 | 26251 | 21646 | 23684 | 3.6 |
| VTP14 | | 3881 | 2563 | 3222 | 0.5 |
| VTP1 | 459 | 428 | 387 | 425 | 0.1 |
| VTP1 | 315 | 258 | 195 | 256 | 0.0 |
| IL-2 | 8606 | 6118 | | 7362 | 0.1 |
| | tolerized with: VTP 15, 15 μg/w | | | | |
| stimulated with: | cpm | cpm | cpm | mean | SI |
| UCO | 10999 | 10701 | | 10850 | |
| VTP14 | 48454 | 36347 | 53222 | 46038 | 4.2 |
| VTP14 | 4039 | 2676 | 4685 | 3800 | 0.4 |
| VTP1 | 1283 | 2082 | | 1683 | 0.2 |
| VTP1 | 719 | 487 | 7467 | 2891 | 0.3 |
| IL-2 | 14646 | 11771 | 14296 | 13571 | 1.3 |
| | tolerized with: VTP 14, 15 μg/w | | | | |
| stimulated with: | cpm | cpm | cpm | mean | SI |
| UCO | 16997 | 12220 | | 14609 | |
| VTP14 | 40639 | 38430 | 38504 | 39191 | 2.7 |
| VTP14 | | 6380 | 2904 | 4642 | 0.3 |
| VTP1 | 243 | 176 | 136 | 185 | 0.0 |
| VTP1 | 143 | 187 | 3080 | 1137 | 0.1 |
| IL-2 | 14336 | 10984 | 15100 | 13473 | 0.9 |
| | tolerized with: VTP 3, 15 μg/w | | | | |
| stimulated with: | cpm | cpm | cpm | mean | SI |
| UCO | 13059 | 22208 | | 17634 | |
| VTP14 | 11472 | 26636 | 21940 | 20016 | 1.1 |
| VTP14 | | 1578 | 3939 | 2759 | 0.2 |
| VTP1 | 338 | 396 | 390 | 375 | 0.0 |
| VTP1 | 227 | 400 | 2750 | 1126 | 0.1 |
| IL-2 | 12402 | 15314 | 20180 | 15965 | 0.9 |

FIG. 14 illustrates that tolerance experiments with a non-allergic individual (AB) were performed to show that peptides can tolerize T-cells in allergen-specific manner. Experiments in non-allergic persons can also show tolerance because tolerance is measured as reduction of T cell reactivity (Ebner et al., J. Immunol. 1995, Vol 154, pp 1932-1940). As long as a non-allergic person contains allergen-reactive T cells, tolerance to the allergen at the T cell level can be measured.

PBMCs were isolated and T-cell- and antigen-presenting cell (APC)-enriched fractions were obtained by MACS-separation technology. T-cell fractions were preincubated over night with high amounts of peptides (αS1-casein peptide 1, αS1-casein peptide 2, αS1-casein peptide 3 and a control peptide, Phl p 5-peptide 1) or with an extensive whey hydrolysate (VTP8) or partial whey/casein hydrolysate (VTP16). On the next day the T-cells and the APCs were combined and stimulated with whole cow's milk protein samples (VTP13, VTP14) or with intact rαS1-casein.

Two experiments were performed with the same individual. In FIGS. 14A and 14C, counts per minute (cpm; reflecting the proliferation of T cells) and in FIGS. 14B and 14D stimulation indices (SIs) are displayed.

More specifically, FIG. 14A illustrates the counts per minute (cpm; reflecting the proliferation of T cells) in T-cell fractions preincubated overnight with high amounts of peptides (αS1-casein peptide 1, αS1-casein peptide 3 and a control peptide, Phl p 5-peptide 1) that were combined and stimulated the next day with whole cow's milk protein samples (VTP13, VTP14) or with IL-2.

FIG. 14B illustrates the stimulation indices for T-cell fractions preincubated overnight with high amounts of peptides (αS1-casein peptide 1, αS1-casein peptide 3 and a control peptide, Phl p 5-peptide 1) that were combined and stimulated the next day with whole cow's milk protein samples (VTP13, VTP14) or with IL-2.

FIG. 14C illustrates the counts per minute (cpm; reflecting the proliferation of T cells) in T-cell fractions preincubated overnight with high amounts of peptides (αS1-casein peptide 1, αS1-casein peptide 2, αS1-casein peptide 3 and a control peptide, Phl p 5-peptide 1) or with an extensive whey hydrolysate (VTP8) or partial whey/casein hydrolysate (VTP16) that were combined and stimulated the next day with intact rαS1-casein or with IL-2.

FIG. 14D illustrates the stimulation indices for T-cell fractions preincubated overnight with high amounts of peptides (αS1-casein peptide 1, αS1-casein peptide 2, αS1-casein peptide 3 and a control peptide, Phl p 5-peptide 1) or with an extensive whey hydrolysate (VTP8) or partial whey/casein hydrolysate (VTP16) that were combined and stimulated the next day with intact rαS1-casein or with IL-2.

### Example 2

### Results

Healthy non-allergic individuals exhibit a normal IgG but no IgE response to cow's milk allergens. In the experiments both quantitative (proliferation) and qualitative (i.e., cytokines) responses in cow's milk allergic individuals as well as healthy non-allergic individuals were compared.

The experiments identified small peptides in the hydrolysates which can block the T cell receptors and MHCII so that there is limited or no proliferation when there is a subsequent exposure to milk allergens. Thus, the experiments identified a fraction so that a tolerance to cow's milk allergens can be induced.

Another approach was to mix in the T cells that have been pre-exposed to peptides/hydrolysates in a culture of T-APC that have been preincubated and restimulated with whole protein preparations. This should demonstrate the capacity of peptides to inhibit/dampen the response to a whole milk protein challenge.

Up to now 6 non-allergic and 7 cow's milk allergic persons were tested regarding lymphoproliferative responses with the 16 cow's milk samples as well as with αS1casein-derived peptides and control antigens. Non-allergic individuals and cow's milk allergic patients induced comparable stimulation indices. The Nutramigen™ samples induced weaker T-cell proliferations compared to the other milk samples. Amino acid formulations induced the weakest responses. VTP13 and 14, identified by SDS-PAGE and mass spectrometry analysis as sources of intact cow's milk proteins, served as controls for tolerance experiments, because they induced strong lymphoproliferative responses. The culture supernatants from 11 of the tested individuals regarding the secretion of 13 cytokines were analyzed by luminex analysis. These results are extremely interesting and surprising for two reasons: First, the analysis of the cytokine levels showed that cytokines driving a Th2 differentiation (GM-CSF, IL-5 and IL-13) and pro-inflammatory cytokines (IL-6, TNF-alpha and IFN-gamma) are induced in low amounts by the Nutramigen™ samples (VTP3, 4, 11, 12, 15). By contrast, a strong induction of pro-inflammatory cytokines (e.g., IFN-gamma, TNF-alpha, IL-6) in the samples VTP2, VTP5 and VTP14 which are only partly hydrolysed or contain intact proteins has been found. In particular, the induction of IFN-gamma seems problematic because evidence exists that IFN-gamma can damage epithelial cells. Amounts of secreted cytokines were in the same range in experiments done with non-allergic and with allergic individuals, except of IFN-gamma, which was stronger upregulated in non-allergic individuals.

Certain cow's milk derived peptides (e.g. alpha S1casein) induce T cell proliferations in PBMC. Since any T cell-reactive peptide can also induce T cell tolerance under certain conditions (e.g., binding to the T cell receptor without appropriate co-stimulation, presence of large amounts of T cell-reactive peptides early in life-infancy) it is assumed that alphaS1casein-derived T cell-reactive peptides can be used for the induction of tolerance to identify additional T cell-reactive peptides. In this respect, tolerogenic activity of the alpha S1casein-derived peptides that will be generated synthetically was demonstrated. PBMC from reactive persons were splitted into T cell fraction and a T cell-depleted fraction (anti-CD3-coupled beads) containing the APCs. The T cell fraction were pre-incubated with the casein-derived peptides and control peptides (grass pollen allergen Bet v1, Phl p 5-derived peptides), washed and then exposed to the APC fraction with the peptides. Using this assay it was possible to demonstrate the milk-specific tolerogenic activity of these casein-derived peptides.

In an effort to search for tolerogenic peptides the culture conditions were successfully established. In a next step one αS1casein-derived candidate peptide which showed in two independent experiments a suppression of T cell responses was identified. The alphaS1-casein-derived peptide 3, when added to an isolated T-cell fraction suppressed the proliferation in the combined T-cell-APC fraction when re-stimulated with whey protein concentrate VTP14 or rαS1-casein. A similar result was obtained for peptide 4. Further, the potential suppressive effects of casein hydrolysates VTP3 (Nutramigen™), VTP11, VTP14 and VTP15 on whole cow's milk protein induced proliferation were studied and it was found that in particular preincubation with Nutramigen™ (VTP3) was able to induce tolerance.

All references cited in this specification, including without limitation, all papers, publications, patents, patent applications, presentations, texts, reports, manuscripts, brochures, books, internet postings, journal articles, periodicals, and the like, while not considered relevant for the patentability of this disclosure, are hereby incorporated by reference into this specification in their entireties. More specifically, all referenced documents are incorporated by reference to the same extent as if each individual document was specifically and individually indicated to be incorporated by reference.

The discussion of the references herein is intended merely to summarize the assertions made by their authors and no admission is made that any reference constitutes prior art. Applicants reserve the right to challenge the accuracy and pertinence of the cited references.

Although preferred embodiments of the disclosure have been described using specific terms, devices, and methods, such description is for illustrative purposes only. The words used are words of description rather than of limitation. It is to be understood that changes and variations may be made by those of ordinary skill in the art without departing from the spirit or the scope of the present disclosure, which is set forth in the following claims. In addition, it should be understood that aspects of the various embodiments may be interchanged both in whole or in part. Therefore, the spirit and scope of the appended claims should not be limited to the description of the preferred versions contained therein.

1. A nutritional formulation or supplement comprising a cow's milk peptide-containing hydrolysate and/or a peptide-containing fraction of the hydrolysate and/or one or more peptides derived from a protein present in cow's milk for use in the induction of tolerance in a human subject,
wherein said peptides contained in the hydrolysate or fraction of hydrolysate comprise T cell epitope-containing peptides or wherein said one or more peptides are T cell epitope-containing peptides, and
wherein said T cell epitope-containing peptides are capable of driving the immune reaction upon intake of the nutritional formulation towards tolerance.

2. The nutritional formulation of claim 1, wherein the tolerance is induced to cow's milk, a protein contained in cow's milk or an allergen contained in cow's milk.

3. A nutritional formulation or supplement comprising a cow's milk peptide-containing hydrolysate and/or a peptide-containing fraction of the hydrolysate and/or one or more peptides derived from a protein present in cow's milk for use in treating or preventing inflammatory bowel disease,
wherein said peptides contained in the hydrolysate or fraction of hydrolysate comprise T cell epitope-containing peptides or wherein said one or more peptides are T cell epitope-containing peptides, and
wherein said T cell epitope-containing peptides are capable of downregulating pro-inflammatory cytokines upon intake of the nutritional formulation.

4. The nutritional formulation of claim 3, wherein the one or more peptides are T cell epitope-containing peptides isolated from the cow's milk peptide-containing hydrolysate.

5. The nutritional formulation of claim 3, wherein the one or more peptides have the amino acid sequence of SEQ ID NO: 3 and/or 4.

6. The nutritional formulation of claim 5, wherein the cow's milk peptide-containing hydrolysate is an extensively hydrolyzed cow's milk peptide-containing hydrolysate.

7. The nutritional formulation of claim 6, wherein the extensively hydrolyzed cow's milk peptide-containing hydrolysate is Nutramigen™, Nutramigen™ base or an extensively hydrolyzed bovine casein-containing hydrolysate.

8. The nutritional formulation of claim 7, wherein the human subject is a child or juvenile.

9. The nutritional formulation of claim 7, wherein the human subject is an adult.

10. The nutritional formulation of claim 9, wherein the human subject has a cow's milk allergy.

11. The nutritional formulation of claim 10, wherein the nutritional formulation additionally comprises one or more of carbohydrates, nucleic acids, lipids, minerals, anabolic nutrients, vitamins, antioxidants, probiotic bacterial strains and lipotropic agents.

12. The nutritional formulation of any of claim 3, wherein the tolerance is induced transiently.
